(19) United States
(12) Patent Application Publication
(10) Pub. No.: US 2002/0107809 A1
(43) Pub. Date: Aug. 8, 2002

(54) System and method for licensing management

(76) Inventors: John Denton Biddle, Scottsdale, AZ (US); Thomas Allen Clarke, Phoenix, AZ (US); Scott Allan Woods, Cave Creck, AZ (US); Keith Wayne Rupp, Glendale, AZ (US)

Correspondence Address: Howard I. Sobelman, Snell & Wilmer, L.L.P., One Arizona Center, Phoenix, AZ, 85004-2202, US

(21) Appl. No.: 09/873,542

(22) Filed: Jun. 4, 2001

Related U.S. Application Data
(60) Provisional application No. 60/208,901, filed on Jun. 2, 2000.

(51) Int. Cl. G06F 17/60

(52) U.S. Cl. 705/59

(57) ABSTRACT

The present invention discloses an improved system and method for managing licensing data that may be applied to any property, product and/or service licensing model. The licensing management system and method may further include client and server managed security features to control or otherwise monitor and/or restrict the use and re-distribution of licensed subject matter. In one specific application, the present invention provides, for example, a system and method for licensing software applications over a network on a user self-serve, subscription-based model. The present invention, in addition to providing “out-of-the-box” functionality, also provides the user with the ability to optionally customize the implementation of the licensing management system to uniquely conform to specific user goals.

### RELATED APPLICATIONS

The present application claims the benefit of and priority to U.S. Provisional Application No. 60/208,901 filed Jun. 2, 2000; the entire content of which is hereby incorporated by reference.

### FIELD OF THE INVENTION

The present invention generally relates to the management of licenses, licensing data and/or other information. More particularly, the present invention relates to a system and method for managing licensee and licensor licensing of, inter alia, property, products and/or services. In one specific aspect, the present invention further relates to a system and method for licensing of software applications over a network.

### BACKGROUND OF THE INVENTION

Many commercial transactions are based on the licensing of property, products or services which may involve a limitation of the scope and/or duration of their use. Accordingly, licensing contracts may operate to restrict or otherwise limit the user's ability to assign, redistribute, resale or otherwise alter the intended beneficiary of the license, while other restrictions may be directed to how, when, where and for how long the use may occur. Both parties generally derive an economic benefit from structuring a transaction in such a fashion: (1) the licensor retains ownership interest in the subject of the license and control over who may make, use or sell the same; and (2) the licensee enjoys the benefit of using the property, product or service at a reduced cost as compared to the licensee having to (a) acquire the subject of the license by freehold, or (b) develop the property, product or service at the expense of other capital resources.

With respect to licensor transactions, the growth of the global market has been a factor in licensing being refined and developed to better serve both economic and strategic business goals. For example, where licensor ‘A’ grants a license to licensee ‘B’, such a license may be granted in consideration of a license granted back from licensee ‘B’ to original licensor ‘A’ (e.g., a cross license). In these circumstances, both party ‘A’ and party ‘B’ will be deemed to have determined that the granting of a cross license strengthens or otherwise prospectively improves their relative positions in the marketplace. Moreover, licenses that have been granted, received and/or traded may be accumulated into a licensing portfolio having tangible economic value which, for example, may be leveraged or borrowed against to fund further capital resource development.

With respect to licensee transactions, individuals encounter a variety of circumstances in their daily lives that involve the licensing of goods and services, such as, for example: renting a house or apartment; renting a hotel room; purchasing a ticket to an amusement park; watching a film at a movie theatre; renting or leasing a car; purchasing a parking pass; obtaining permission from the state to operate a motor vehicle or to place a particular motor vehicle in service; purchasing a membership at a discount warehouse store; flying on a commercial airline; using a passport or obtaining a visa to enter a foreign country; making a telephone call with a calling card; using computer software applications; casting a vote at a shareholder's annual meeting; or joining a country club; etc.

With the growth of licensing business models, problems involving the efficient distribution, authorized conveyance, tracking, and management of licenses, both by licensees and licensors, has grown as well. By way of example, in the commercial software industry, for instance, software application products have generally been sold on a purchase basis with license agreements for limited use of the software. Sales representatives often market the software to prospective end-users and, upon purchase in a conventional fashion, the software is then provided to the user on diskettes or other media along with, for example, user manuals. As such, many software applications have been sold primarily on a long-term or permanent license basis with support service being provided under long-term, fixed-price contracts.

From an end-user's perspective, software acquisition under a conventional purchase based license agreement can be expensive. Specifically, once an end-user initially invests in a conventional software purchase, the purchase based acquisition of additional software titles from other vendors may not be feasible. Moreover, the vendor may charge the user for application upgrades and continuing product support. In this regard, many end-users may become overly dependent on a particular vendor and/or application product. Under such circumstances, the end-user may not have the flexibility to manage costs efficiently. Moreover, even though the software may only be required several months out of a year or relatively few times in the user's development cycle, the user typically still obtains a long-term license in order to use the software under the terms of a conventional purchase based license agreement. This can be disadvantageous for end-user's, particularly considering the limited shelf-life of most software titles. Moreover, because resources are already allocated, end-users may experience constraints on their ability to acquire or convert to superior software tools and services as they may become available.

From a software application vendor's perspective, a large portion of revenue is generally spent on sales, marketing and user support through direct sales and the use of VAR (value added reseller) channels. However, Internet access and the proliferation of high speed connections (i.e., T1, cable and DSL) have made the electronic distribution of software application products more feasible. As the popularity and accessibility of the Internet has grown, vendors have increasingly looked to the Internet as an effective medium for reducing sales and marketing costs. As a result, some vendors have expanded to support electronic purchase and delivery of software applications over the Internet, but generally under the conventional purchase based license agreement model discussed immediately above. However, the prior art has not solved the problem of providing a comprehensive method to manage, track and customize, inter alia, software application licenses.

In addition to cost and efficiency concerns, vendors often are confronted with the issue of software piracy and other unlicensed, unauthorized or illegal use. As a result, vendors have generally implemented certain security features within software products to protect the application from unlicensed use. The vendor may therefore find that expensive additional resources are required to support the licensing security features in addition to support for the application itself In many instances, the support for an application may include live telephone support; however, as many as 50% of the technical support calls that a vendor receives may involve licensing issues. Often, this can prove to be a burden on the vendor's available development resources. Accordingly, having an extensible licensing management system to use, in one exemplary aspect, for the electronic distribution of application products would substantially improve the ability of software vendors to more efficiently reallocate resources to, for example, application development.

The electronic distribution of software applications also poses a security risk for many vendors. Conventionally, where an encryption method may be employed to protect the software code, protection after decryption of the software may be minimal or non-existent. Accordingly, once the software has been delivered to the end-user's platform, it may be difficult for the vendor to protect against tampering and software piracy. Furthermore, the electronic security solutions implemented by vendors are not necessarily safe for the user. For example, the user may be required to maintain a data connection with the Application Service Provider (ASP) while using the distributed software. An ASP working environment may also require the user to upload potentially sensitive data to the vendor site, thereby introducing security issues in those circumstances where the user may be excluded from running the distributed application if access to the vendor site is occupied by other users.

Software application vendors, therefore, are faced with several challenges when trying to establish and manage product licensing for their products, such as: managing order entry; tracking product use; offering multiple licensing options; integrating license management into product installation; ensuring licensing information and product source are secure; managing distributed support across a network; customizing the licensing process; giving end-user's control over how their licenses are dynamically distributed and employed; and controlling the cost and complexity of license management; etc.

There is therefore a need to address these and similar deficiencies associated with the effective and efficient management of licensing in a wide variety of licensee and licensor market environments. With respect to the software application industry in particular, a need exists for a turnkey electronic method for obtaining licenses and distributing software applications on an as needed basis. A need also exists for a network-based system that allows software user's online access to a variety of application tools that may be used on a trial basis to determine product usefulness and then purchased in a secure, convenient fashion for as long as the application product is needed or on a subscription basis. A need also exists for a secure method for vendor distribution of software and for maintaining security on the end-user's platform. Additionally, a need also exists for dynamic user-level management of the distribution and use of software application licenses.

### SUMMARY OF THE INVENTION

The present invention discloses an improved system and method for managing licenses. The system may be embodied as a comprehensive computer implemented method for permitting licensor and licensee management of the licensing of property, products, and/or services. In one exemplary embodiment, the licensor features permit distribution, tracking and information management of licenses sold or otherwise granted to merchants or consumers. In another exemplary embodiment, the licensee features permit redistribution, reallocation, renewal, tracking, organization and information management of licenses purchased or otherwise granted to the consumer.

The present invention also describes, in one exemplary application, a system and method for the effective management of software application licensing implemented with, for example, a client-server model which includes a method of wrapping licensing instructions around a software product and integrating licensing management as part of the installation process. A database is generally maintained on a license server while other client-side activities may be performed, whereby database administration, product definitions, scripting, product wrapping, purchase orders, and user installations may be handled remotely using a data messaging protocol with the licensing server. The structure and flow of licensing management is improved, resulting in reduction of cost and minimization of complexity associated with vendor and end-user licensing management. Moreover, the system and method permits a software vendor to optionally customize the implementation of the licensing management system to uniquely conform to specific vendor goals. Additionally, the system and method allows the end-user to distribute, track and manage an application license library for administering multiple licenses.

The software licensing management method includes the following exemplary steps: (1) the vendor/developer creates a software application product to be licensed; (2) the vendor/developer identifies a hardware system to act as a licensing management platform and installs the license management server software on that system; (3) using tools integrated with the licensing management software, the vendor/developer generates optionally customized instructions for wrapping license management code around the application to create a license management protected application; (4) the protected application may then be packaged and delivered to end-user licensees for subsequent installation and use; (5) when a local instance of the protected application is instantiated by the end-user licensee management client, the management client requests authorization from the license management server to provide appropriate access to the wrapped application; and (6) the vendor/developer installs optionally customized database views for order fulfillment and field support systems to receive product orders and/or to manage sales.

A global location for third party software development companies to distribute software tools is also disclosed. The licensing model may be implemented using an electronic storefront provided through, for example, a website that may be owned and maintained by a distributor. Users access and search the electronic store by using, for example, a web browser and then download third party software applications wherein the downloaded software includes security to control the use and re-distribution of the application. A license to use or redistribute the software may then be purchased by a user for a specified time period. The distributor may be responsible for handling security violations thereby reducing the vendor's/developer's reallocation of development resources to monitor or to support licensing of software. The global location distribution model is especially applicable for design engineers who may download software applications which are used as design tools in the Electronic Design Automation (EDA) field. The end-user can elect to use the software on a trial basis to determine if the software conforms to user expectations and requirements or on a subscription basis for a period of time. Moreover, the user may use the software for the subscribed period of time and then either renew or cancel the subscription.

In one aspect of the present invention, the vendor may be a third party developer, wherein the vendor may also maintain substantial control of the distribution, tracking and management of software licenses granted to customers and where vendors may also prefer to control the processes of integrating the appropriate licensing information and security measures into the software application instead of allowing a distributor to perform those functions. A vendor may also prefer to have improved control over the distribution of their own and other third party software to customers thus taking on the role of distributor as well as third party developer/vendor. In an alternative embodiment, the distributor provides the vendor with a software licensing system (SLS) whereby the vendor receives the tools to: (1) install a licensing server and establish a default database on existing vendor hardware; (2) customize and integrate licensing information into the software product; and (3) administer or otherwise manage licenses for vendor software products. In this particular embodiment, the vendor would not need to allocate valuable resources to develop the software licensing and security code; rather, the vendor may purchase the license management code, in the form, for example, of a pre-packaged system from the distributor on a subscription basis. The license management system also allows the vendor to set up a database and a server to distribute, track and manage software licenses over a network. Additionally, the distributor of the SLS may optionally host the database for the vendor remotely, if the vendor so desires. A user may then access and search, for example, a vendor's website using a web browser to download a desired software application. The first time the user runs the software application after installation, the user is prompted to provide registration information to obtain a license. In an alternate embodiment of the present invention, the distributor for the SLS may also have the SLS installed to distribute, track and manage the licensing of the SLS to various vendors.

The licensing management system and method may provide the following advantages, features, improvements and services in the software application industry: (1) a software-only implementation that eliminates the cost and administration associated with hardware-based keys; (2) a turnkey vendor implementation with a simplified installation for the end user; (3) network-enabled licensing and upgrades through direct and/or third-party channels administered from a centralized location; (4) flexible, term-based licensing models (such as variable durations and trial offerings) that the vendor/developer can specify and modify dynamically; (5) support for customer self-service access to prepaid subscription offerings where the customer acquires additional licenses or other software titles over the internet without direct vendor contact; (6) comprehensive database tools that collect and maintain, for example, product, license, and user information and that provide reports and other services to assist in customer retention management programs; (7) support for extensible scripting that can be used to generate custom messages and gather information for marketing, field support, or other interested parties; (8) license portability in which licenses may be dynamically managed by end-users and transferred from one machine to another; and (9) multiple security layers to protect against unlicensed access.

### BRIEF DESCRIPTION OF THE DRAWINGS

The above and other features and advantages of the present invention are hereinafter described in the following detailed description of illustrative embodiments to be read in conjunction with the accompanying drawings and figures, wherein like reference numerals are used to identify the same or similar system parts and/or method steps in the similar views and:

FIG. 1 is a block diagram depicting an exemplary overview of one embodiment of the present invention;

FIG. 2 is a block diagram expanding on FIG. 1 by depicting exemplary details of one embodiment of the present invention;

FIG. 3 is a diagram depicting exemplary database structure in accordance with another embodiment of the present invention.

FIG. 4 is a table depicting an overview of various exemplary view options for a licensing server access tool in accordance with another embodiment of the present invention;

FIG. 5 is a screenshot showing exemplary details of a database administration utility in accordance with another embodiment of the present invention;

FIG. 6 is a screenshot showing exemplary details of a user administration utility feature in accordance with another embodiment of the present invention;

FIG. 7 is a screenshot showing further exemplary details of the user administration utility depicted in FIG. 6 in accordance with yet another embodiment of the present invention;

FIG. 8 is a screenshot showing exemplary details of a product administration utility feature in accordance with another embodiment of the present invention;

FIG. 9 is a screenshot showing exemplary details of a script administration utility feature in accordance with another embodiment of the present invention;

FIG. 10 is a screenshot showing exemplary details of a script editing and building utility feature in accordance with another embodiment of the present invention;

FIG. 11 is a screenshot showing exemplary details of a wrapping utility feature in accordance with another embodiment of the present invention;

FIG. 12 depicts exemplary client default license script code in accordance with another embodiment of the present invention;

FIG. 13 is a screenshot showing exemplary details of a product ordering utility feature in accordance with another embodiment of the present invention;

FIG. 14 is a screenshot showing further exemplary details of the product ordering utility depicted in FIG. 13 in accordance with yet another embodiment of the present invention;

FIG. 15 is a screenshot showing exemplary details of a client license management user interface in accordance with another embodiment of the present invention;

FIG. 16 is a screenshot showing further exemplary details of the client license management user interface depicted in FIG. 15 in accordance with yet another embodiment of the present invention;

FIG. 17 is a block diagram depicting exemplary functions of an online commerce system in accordance with another embodiment of the present invention;

FIG. 18 is a block diagram depicting an exemplary process for preparing vendor software in accordance with another embodiment of the present invention;

FIG. 19 is a flow chart illustrating an exemplary method for licensing the software to a user in accordance with another embodiment of the present invention;

FIG. 20 is a flow chart illustrating an exemplary process for subscribing for a license in accordance with another embodiment of the present invention;

FIG. 21 is a screenshot of an exemplary software application to be licensed in accordance with another embodiment of the present invention;

FIG. 22 is a screenshot showing exemplary selectable features and options associated with a software application to be licensed in accordance with another embodiment of the present invention;

FIG. 23 is a screenshot showing exemplary confirmation of selected levels and options of a software application to be licensed in accordance with another embodiment of the present invention;

FIG. 24 is a screenshot showing exemplary confirmation of the licensee user computer information in accordance with another embodiment of the present invention;

FIG. 25 is a screenshot showing exemplary confirmation of the licensee's selected payment method in accordance with another embodiment of the present invention;

FIG. 26 is a screenshot showing an exemplary receipt for the purchase of a license in accordance with another embodiment of the present invention; and

FIG. 27 is a screenshot showing exemplary details of subscription information associated with a particular account in accordance with another embodiment of the present invention;

Other aspects and features of the present invention will be more fully apparent from the detailed description that follows.

### DETAILED DESCRIPTION OF EXEMPLARY EMBODIMENTS

Various exemplary implementations of the present invention may be applied to any property, product, service and/or intellectual property licensing model utilizing a computer-based system and method for the management of licensing portfolios. The implementations include, for example: the leasing of real property; the leasing of chattels; the licensing of copyrights, trademarks, patents, and/or trade secrets; the licensing of any other form of intellectual property hereafter derived by those skilled in the art; the licensing of services; and the licensing of non-possessory interests and/or rights, such as, for example, a right of reentry to land, a remainder interest, a life estate, a right to exercise an option under an options contract; etc. As used herein, the terms “license” and “licensing”, or any variation thereof, are intended to denote anything that is currently susceptible to being licensed or otherwise abstractly or concretely transacted between at least two parties where at least one party retains at least partial control over the nature and/or duration of use of the subject of the transaction, or anything that may hereafter lend itself to the same or similar characterization. The same shall properly be regarded as within the scope and ambit of the present invention. By way of example, a detailed description of an exemplary application, namely the licensing of computer software, is provided as a specific enabling disclosure which may be generalized by those skilled in the art to any application of the disclosed computer-based system and method of licensing management in accordance with the present invention.

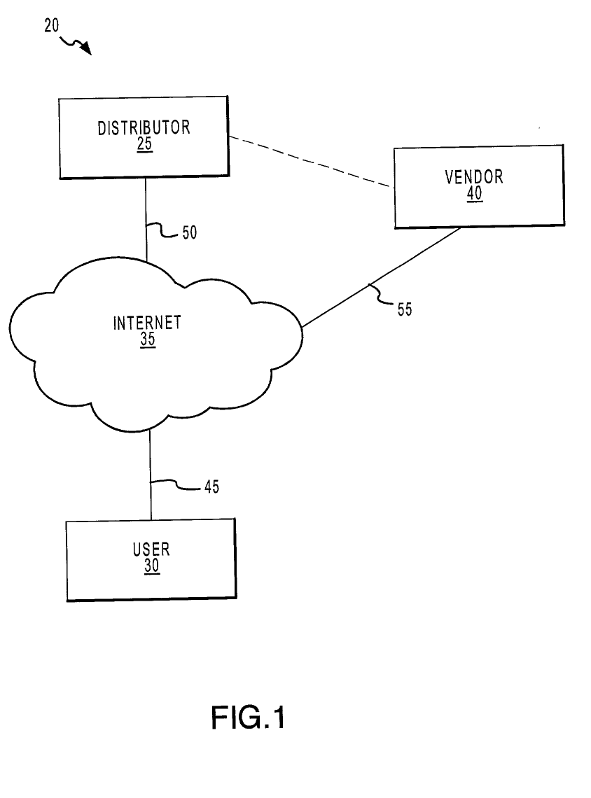

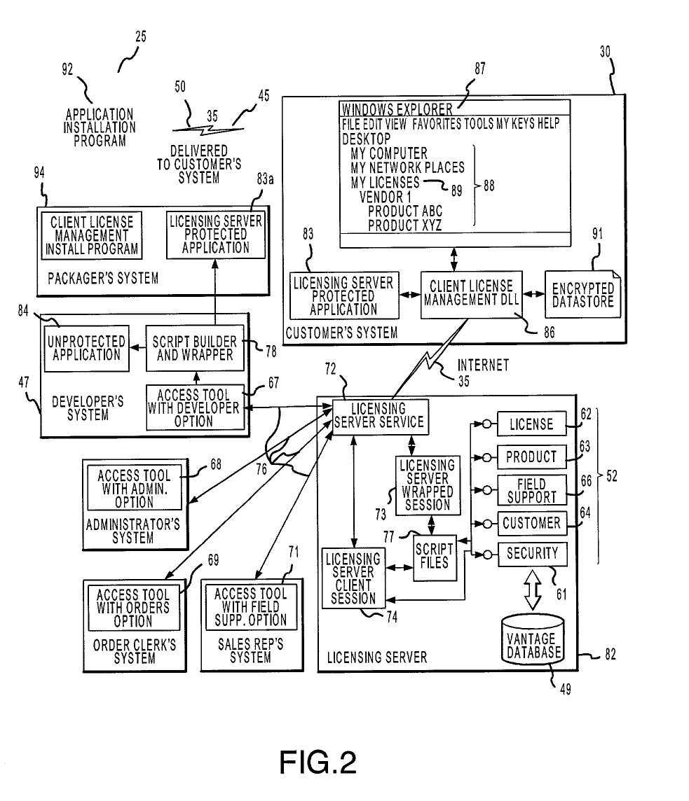

Systems and methods in accordance with exemplary computer software implementations of the present invention may provide for, inter alia, a subscription-based, cost-effective, software licensing model enabling access to a variety of software applications over a computer network, such as, for example, the Internet. Referring now to FIG. 1 and 2, in one exemplary embodiment, a distribution system 20 is utilized to provide for the downloading of software from a distributor computer 25 to a user computer 30 and a licensing model is executed through secure, online transactions between the distributor 25 and the user 30. The distributor computer 25 and the user computer 30 are interconnected via respective data links 45, 50 and 55 to a network, such as Internet 35, for data communications. Thus, distribution system 20, namely the downloading of software and the secure online transactions enabling the purchase of a license to use the software on a subscription basis, can be conducted over the Internet 35.

User 30 represents, for example, individual people, entities or businesses, and is equipped with a computing system to facilitate online commerce transactions. The user computer 30 can be any type of computing device, such as, but not limited to, desktop computers, workstations, laptops, handheld computers and/or mainframe computers. As those skilled in the art will appreciate, user computer 30 will typically include an operating system (e.g., Windows 95/97/98/2000, Linux, Solaris, etc.) as well as various conventional support software and drivers typically associated with computers. User computer 30 may be located, for example, in a home or business environment with access to a network. In an exemplary embodiment, access is through the Internet 35 through a commercially-available web-browser software package.

Distributor computer 25 comprises any combination of hardware, software, and networking components configured to receive and process requests from users 30. In addition, distributor computer 25 provides a suitable website or other Internet-based graphical user interface which is accessible by users 30. In one embodiment, the Internet Information Server, Microsoft Transaction Server, and Microsoft SQL Server, are used in conjunction with the Microsoft operating system, Microsoft NT web server software, a Microsoft SQL database system, and a Microsoft Commerce Server. Additionally, components such as Access Sequel Server, Oracle, Mysequel, Interbase, etc., may be used to provide, for example, an ADO-compliant database management system. The term “webpage” as it is used herein is not meant to limit the type of documents and applications that might be used to interact with the user 30. For example, a typical website might include, in addition to standard HTML documents, various forms, Java applets, Javascript, active server pages (ASP), common gateway interface scripts (CGI), extensible markup language (XML), dynamic HTML, cascading style sheets (CSS), helper applications, plug-ins, and the like.

The vendor computer 40 comprises any combination of hardware, software, and networking components configured for a software development environment and that suitably provides the vendor access to the Internet 35. A variety of conventional communications media and protocols may be used for data links 45, 50 and 55. Such links might include, for example, a connection to an Internet Service Provider (ISP) over the local loop as is typically used in connection with standard modem communication, cable modem, Dish networks, ISDN, Digital Subscriber Line (xDSL), or various wireless communication methods. User computer 30 might also reside within a local area network (LAN) which interfaces to network 35 via a leased line (T1, DS3, etc.). Such communication methods are well known in the art, and are covered in a variety of standard texts. See, for example, GILBERT HELD, UNDERSTANDING DATA COMMUNICATIONS (1996), incorporated herein by reference. In an exemplary embodiment, the present invention is suitably deployed in the context of a large user-base, so network 35 as depicted in FIG. 1 preferably corresponds to the Internet 35. As used herein, the term “Internet” refers to the global, packet-switched network utilizing the TCP/IP suite of protocols or any other suitable protocols. Nevertheless, the present invention may be implemented in other network contexts, including any future alternatives to the Internet, as well as other suitable “Internetworks” based on other open or proprietary protocols. For further information regarding specific information related to the protocols, standards, and application software utilized in connection with the Internet, see, for example, DILIP NAIK, INTERNET STANDARDS AND PROTOCOLS (1998); JAVA 2 COMPLETE, various authors, (Sybex 1999); DEBORAH RAY AND ERIC RAY, MASTERING HTML 4.0 (1997). LOSHIN, TCP/IP CLEARLY EXPLAINED (1997). All of these texts are hereby incorporated by reference.

In an exemplary embodiment, distribution system 20 as represented in FIG. 1, is implemented between the distributor 25, the vendor 40, and the user 30. Alternatively, the vendor 40 does not have to be connected to the Internet; however, the vendor may enter an agreement with the distributor to allow the vendor's software to be offered as one of the products in the online distribution system 20. Additionally, a vendor 40 can also assume the role of distributor 25 by purchasing a licensing system from a distributor 25 and carrying out the function of distributing software products directly to the user rather than giving the software product back to the distributor for distribution. For general discussion purposes, one vendor 40 and one user 30 is shown. However, multiple vendors 40 can have agreements with the distributor 25 or the distributor 25 can offer software applications developed by, or acquired by, the distributor. Also, multiple users 30 can have access to the distributor. Distributor 25 may include a website to offer and engage in an online commerce system such that the distributor can make contact with users 30 and vendors to offer the products and services associated with the system. Alternatively, in the instance where the vendor 40 is also the distributor 25, contact can be made between multiple users and a particular vendor 40.

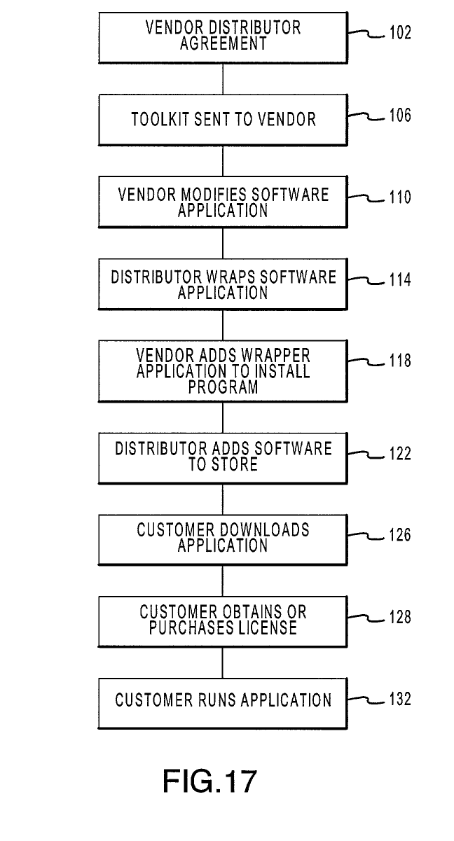

In general, an exemplary process by which a global on-line commerce system may be constructed is represented in FIG. 17. It should be understood that the exemplary process illustrated anywhere herein may include more or less steps or may be performed in the context of a larger processing scheme. Furthermore, the various flowcharts presented in the drawings are not to be construed, inter alia, as limiting the order, number, omission, addition or other variation of individual process steps that may be performed. After an agreement between a software vendor 40 and distributor 25 (step 102) has been finalized, the distributor 25 sends a “toolkit” to the vendor (step 106). Vendor 40 uses the toolkit to prepare the vendor software by making modifications to the software applications (step 110). Vendor 40 then compiles the software application with the new modifications and additions and sends the compiled version of the software to the distributor 25. The distributor 25 wraps the software and sends it back to the vendor 40 (step 114). The vendor 40 then adds the wrapped software application to an install program (step 118) and sends it back to the distributor 25. The distributor 25 then adds the software application to the electronic store (step 122) to allow users 30 to download the software application to a user computer (step 126). After downloading and installing the application, user 30 has the option of obtaining a license for the application, for example, either in the form of a free trial period, by purchasing a subscription, or purchasing a long-term license (step 128). After obtaining a license, user 30 can then run the application (step 132).

In an alternative exemplary embodiment, a vendor purchases a software licensing system (SLS) from the distributor 25 which includes at least a licensing server module 82 and at least an access tool 67, 68, 69 or 71, for example, as shown in FIG. 2. Distributor 25 sends the system to the vendor 40 with vendor 40 using the tools in the SLS (82 and at least one of 67, 68, 69, or 71) to integrate licensing information and security measures into the software application. Various methods for securing the executable code now known or hereafter derived by those skilled in the art may be used to secure the software application. The SLS (82 and at least one of 67, 68, 69, or 71) allows the vendor 40 to customize the licensing and security information to fit the needs of a particular software application. In addition to modifying the vendor software, vendor 40 uses the SLS (82 and at least one of 67, 68, 69, or 71) to establish a database and a method for tracking and managing software licenses.

The SLS (82 and at least one of 67, 68, 69, or 71) is composed of several programming tools. There are at least two install programs that install on the vendor 40 hardware: the code for establishing a licensing server with a database (server-side tools); and the code to modify software applications, manage, track and distribute licenses (client-side tools). The first install program for server-side tools installs the licensing server onto the vendor's server system.

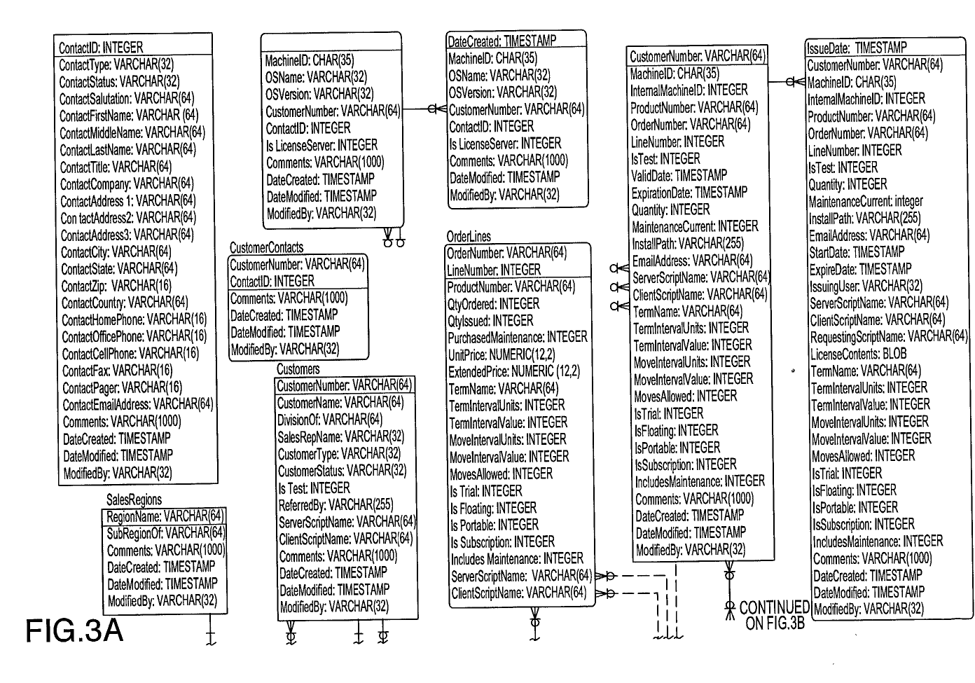

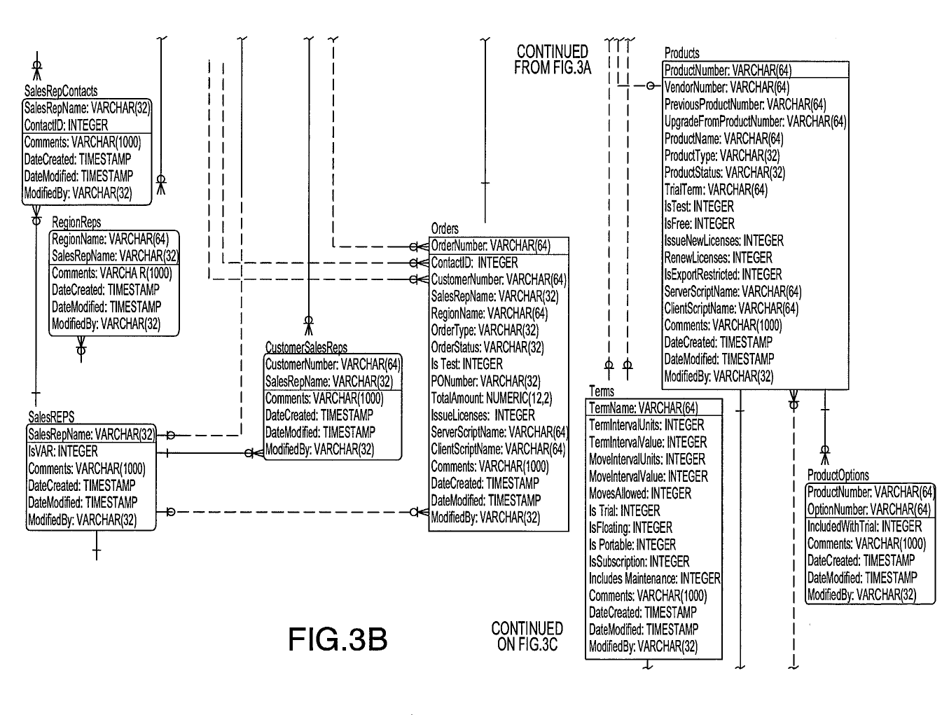

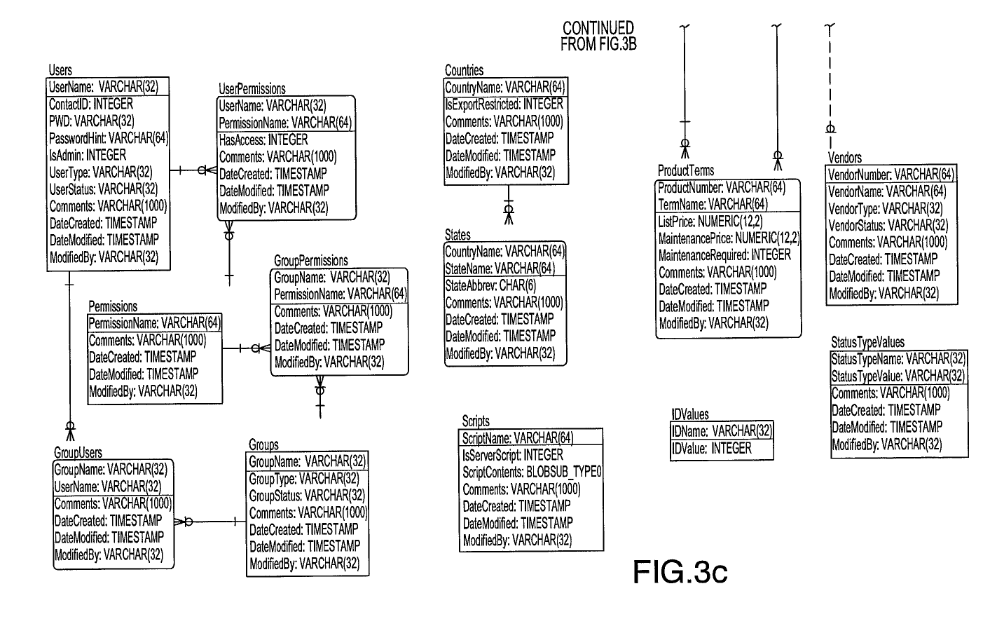

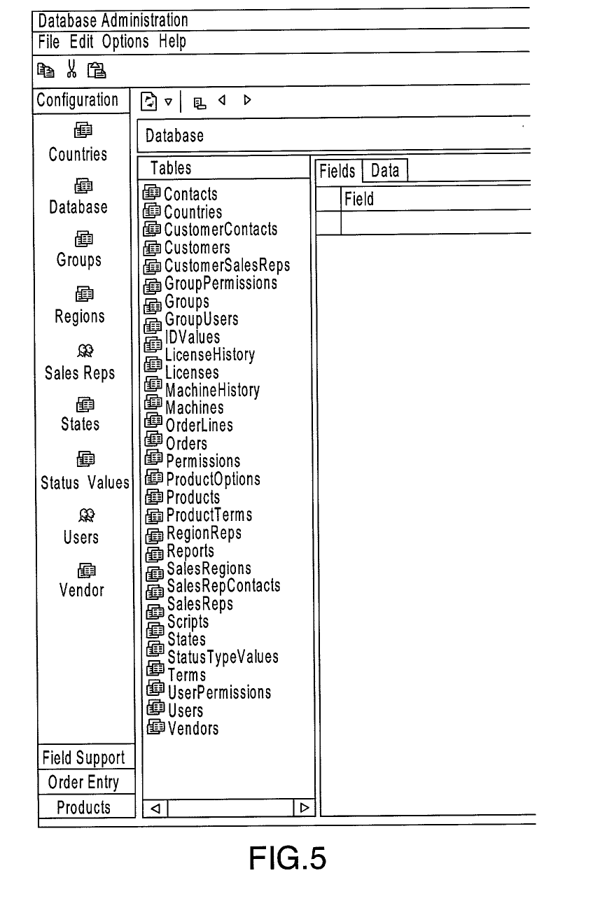

The licensing server installation program may use, for example, the InstallShield mechanism to install the product. Installing the licensing server typically includes minimal input by vendor 40. Thereafter, a database management system, such as, for example, an ADO-compliant database management system, is confirmed to exist on the server. A database is then specified that can be used as the licensing database 49. The licensing server installation program populates the licensing database 49 with default data and the licensing table structure 52 as shown, for example, in FIG. 3. Thereafter, in another exemplary embodiment, database objects may be optionally customized using a database administration utility, such as the one substantially as shown, for example, in FIGS. 5, 6, 7 and 8. In a preferred exemplary embodiment, a ‘create license database’ program is run by the install program to establish on an existing, ADO-compatible database 49 management system, the fields and default values to store customer and licensing information. Using a development environment, vendor 40 can add additional fields to the database 49 to track additional data. If vendor 40 does not have a database management system, a copy of, for example, an ADO compliant database may optionally be included in the SLS (82 and at least one of 67, 68, 69, or 71). If an existing database 49 is designated, the program may be adapted to add the licensing tables to that database 49. In one embodiment, the program may generate an error and prevent overwriting if tables with the same names as the licensing tables exist.

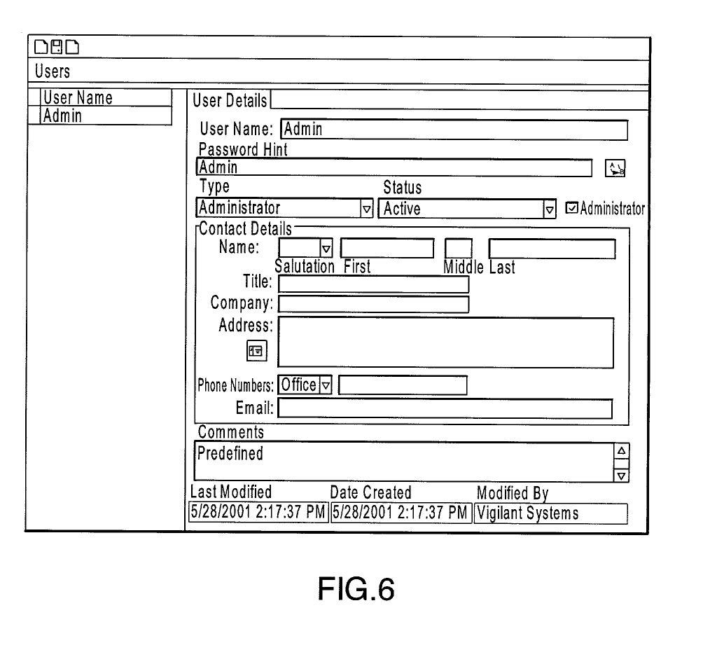

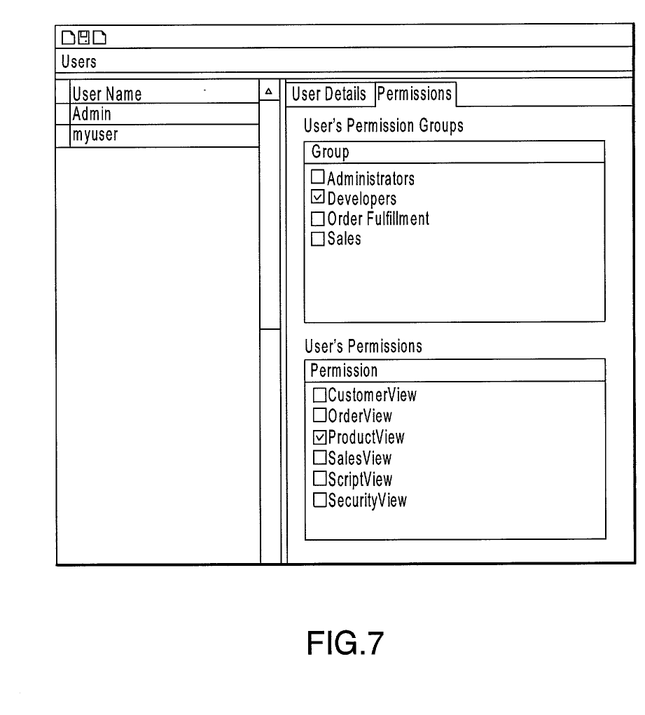

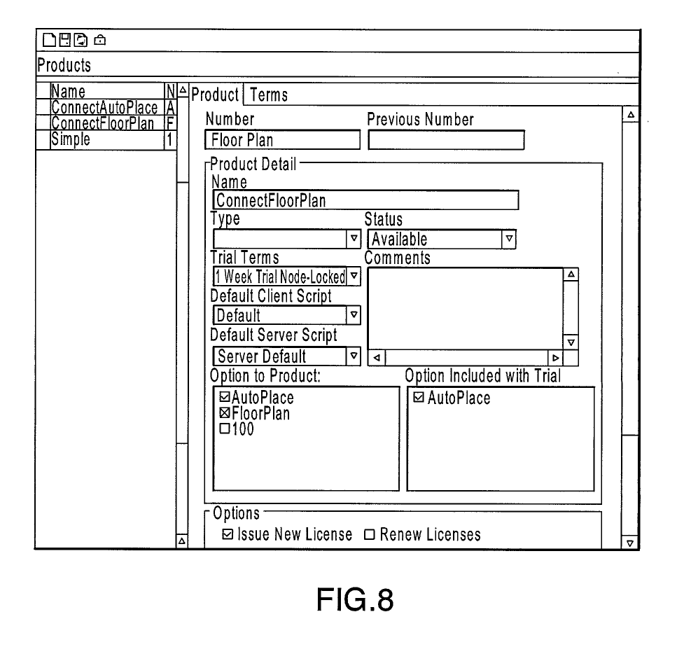

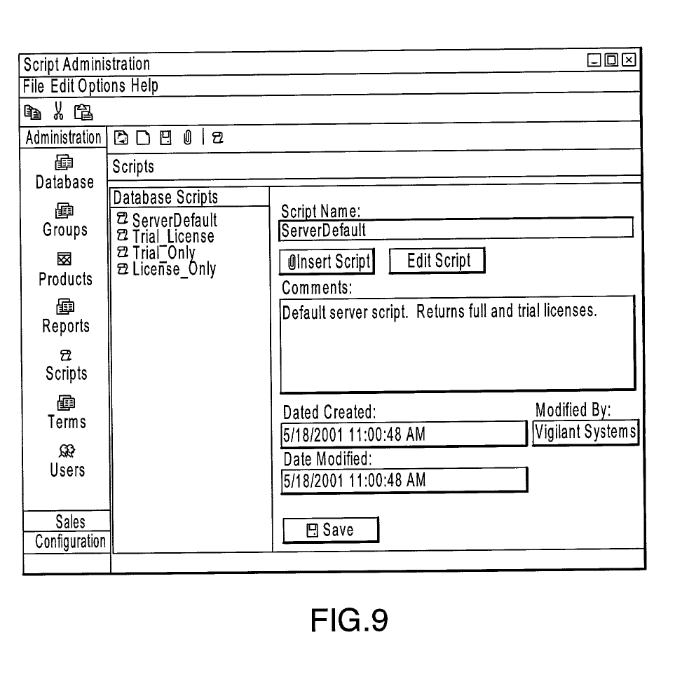

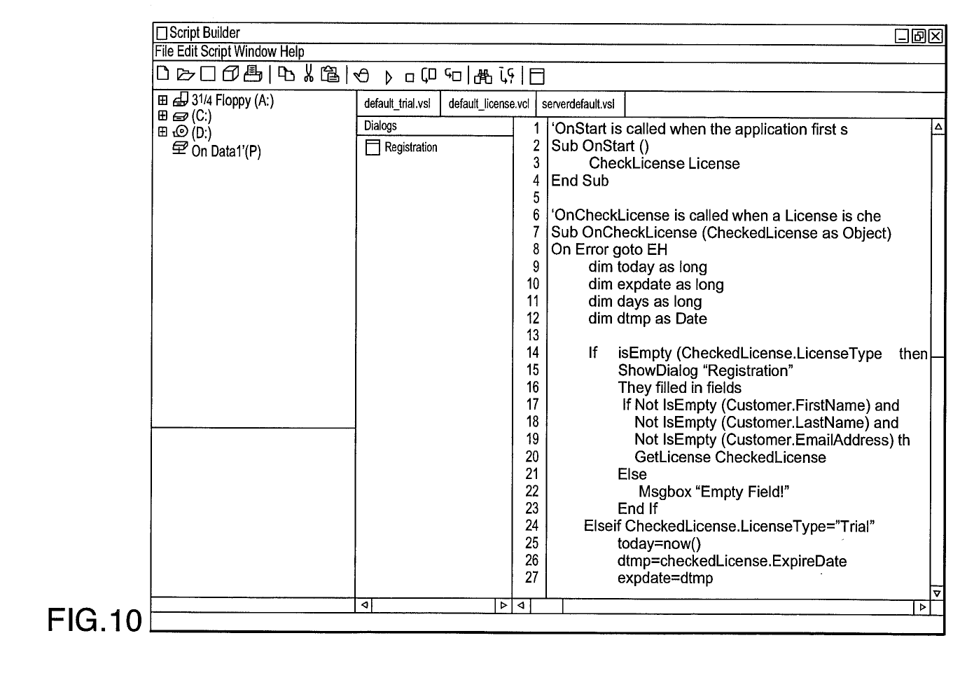

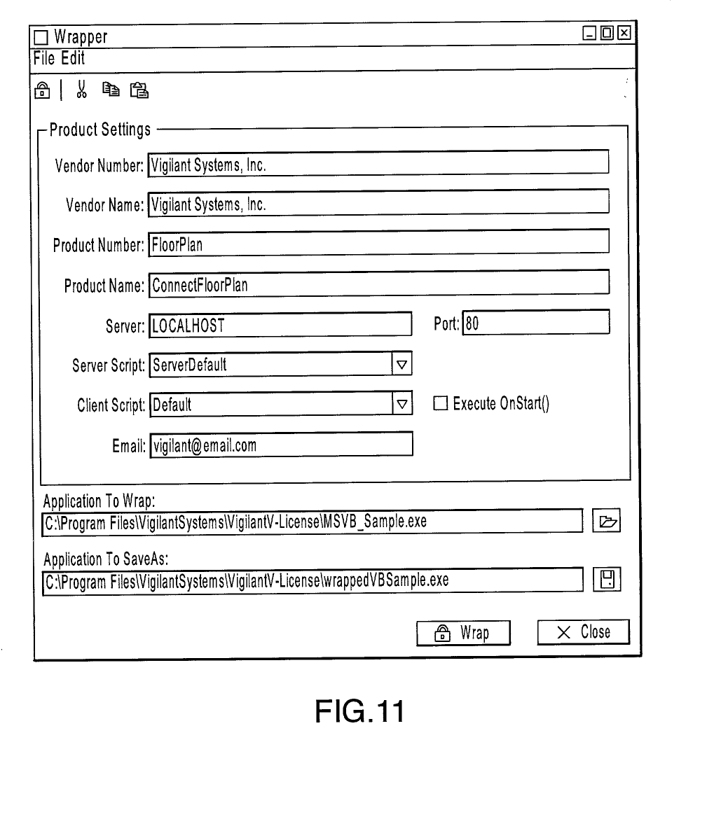

Additionally, in one exemplary embodiment, the server side installation program installs at least one object that the licensing server supports. The objects are independent program modules designed to work together at runtime without prior linking or compiling and may be addressed by script writers to access the licensing database 49 using, for example, a script editing or building tools, such as the scripting utilities shown in FIG. 9 and 10. These objects provide an abstraction level that shields the script writer from having to understand the underlying schema and insert a layer of protection to the underlying database 49. The SLS (82 and at least one of 67, 68, 69, or 71) provides an application programming interface (API) to address these objects. In addition to these objects the vendor may add additional objects to support the distribution of software over the internet or for any other purpose that the vendor may have. Exemplary default objects may include the following: (1) a security object 61 which may be used to control access to information stored in the licensing database 49 (see, for example, FIG. 6 and 7); (2) a license object 62 which may be used to generate license files for protected software; (3) a product object (see, for example, FIG. 8) 63 which may be used to configure and customize the protection for a product to be wrapped by the wrapping tool (FIG. 11); (4) a customer object 64 which may be used to record information about the vendor's customers; and (5) a field support object 66 which may be used to record field support information.

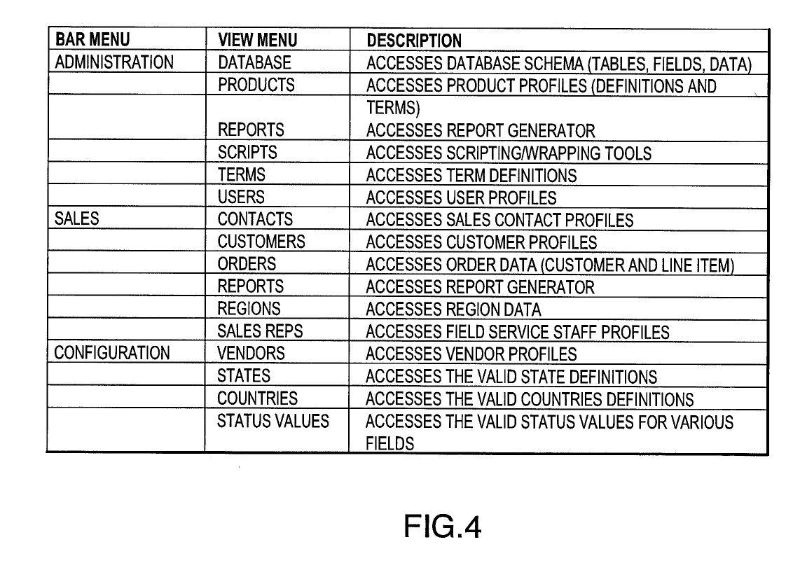

Another feature installed as part of the server-side tools is a license management and access control service 72 (licensing server service). This is installed, in one preferred exemplary embodiment, as a system service on the licensing server for controlling access to the database 49 by the vendor 40 using an access tool 67, 68, 69 or 71 and by the user 30 running a protected application. The table in FIG. 4 shows exemplary program features and various views available to the user 30 when using access tool 67, 68, 69 or 71. The service 72, in one exemplary aspect, listens for incoming requests on a specified port, determines how many license requests may be processed at one time and the length of time that a license request will run before being terminated; and processes license requests. In one embodiment of the present invention, when an inbound license request arrives, an instance of the script engine is spawned to process the request. The service keeps track of how long a request has been running and requests that exceed the timeout value are aborted. Requests are logged, for example, according to log settings after the request is completed. The log settings control the folder set up to receive log files and the level of detail captured in the log file. Information captured may include the originating IP address, the time the request arrived, the size of the request, the product ID/version number, the machine ID, the name of the script executed, the time taken to process the request, and the overall results of the request. In addition, the actual content of the request may be captured and used by, for example, an Integrated Development Environment (IDE) for debugging purposes.

In another exemplary aspect of the present invention, the access control service is responsible for creating the appropriate session to process requests. There may be at least two kinds of sessions: a wrapped session 73 created to process each license request sent by protected applications where the request is validated by the session and server-side scripts are executed to process the request; and a client session 74 created for each instance of the access tool connected to the licensing server where the request is validated and the licensing database 49 is accessed using server objects. The client session 74 remains active until the access tool 67, 68, 69 or 71 exits or the network connection is lost.

Script files 77 may also be installed on the server as part of the server-side tools. Default scripts come with the SLS (82 and at least one of 67, 68, 69, or 71); however, the access tool with a developer option 67 can be used to customize the scripts and create new ones using a script builder tool 78, as shown, for example, in FIG.'S 9 and 10. The scripts are executed by either the wrapped session 73 or client session 74 created by the access control service 72.

A second install program may be adapted to install client side tools including the access tool 67, 68, 69, or 71 used to configure, manage, and view the data stored in the licensing database 49. The functions in the access tool 67, 68, 69, or 71 may be partitioned into several operational modes. When the vendor 40 purchases the SLS (82 and at least one of 67, 68, 69, or 71) from the distributor 30, the desired areas of the access tool are specified and the license for the SLS (82 and at least one of 67, 68, 69, or 71) includes access to those specified areas. The access tool provides a common user interface with appropriate screens and access for each of the areas. The access tool is used to address the database 49 once the licensing server is installed. Because these are client-side tools, they may reside on distributed systems and interact with the licensing server 82, for example, through a network 76 or across the Internet.

One operational mode of the access tool may include an administration option 68 to allow administrators substantially full access to all client tool capabilities. In a preferred exemplary embodiment, vendors are given at least one administration option license. Exemplary functionality provided in this operational mode allows an administrator to setup and maintain SLS (82 and at least one of 67, 68, 69, or 71) users, groups, and their permissions to control access to the data stored in the licensing database 49; setup and maintain products and their license terms; control which users or groups of users can issue which types of licenses; create and execute administrative reports from the licensing database 49.

The administration option 68 allows the vendor 40 to function as a traditional database administrator. The SLS (82 and at least one of 67, 68, 69, or 71) may, in one embodiment, be based on a standard relational database. In this alternative embodiment, the database schema is automatically created when the licensing server 82 is installed and the administrator performs standard tasks of a database administrator (for example, creating user access and setting permissions).

Another operational mode of the access tool may be a developer option 67. The access tool with the developer option 67 may include, for example, a script builder and wrapper 78 (FIG.'S 9, 10 and 11). These tools provide functionality to allow a vendor's developers to login to the licensing server to create a secure client session 74; develop and test scripts to be used by protected applications 83 and wrapped sessions 73; and create protected applications 83 by wrapping a script and a vendor's application into a secured program using a wrapping tool 78, such as, for example, the one shown in FIG. 11.

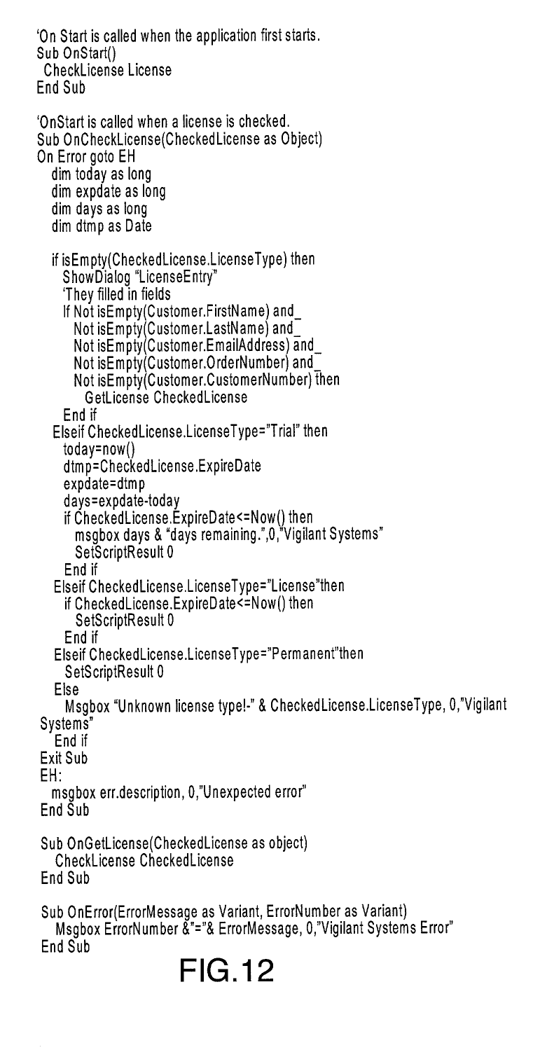

In an alternative embodiment, the developer may convert the vendor's application to a protected application 83 by combining SLS (82 and at least one of 67, 68, 69, or 71) or vendor-defined scripts and dialogs with the unprotected application 84. Depending on the script wrapped with the application, such as, for example the exemplary script shown in FIG. 12, a protected application 83 may check for a valid license for the protected application 83; prompt the user for identifying information (name, email address, customer number, etc.); send such information, which may be optionally encrypted, along with, for example, a product number and machine ID to the licensing server 82 to obtain a trial, subscription, or permanent license; monitor the application 83 for tampering before and/or during program execution; perform other user 30 communication functions, such as announcing new releases or reminding user 30 of upcoming renewal dates. The developer option 67 provides the interface for creating, for example, an encrypted licensing wrapper around the application, and may allow the developer to add custom scripts as desired.

Another operational mode of the access tool, for example, may be a field support option 71. The access tool with the field support option 71 provides functionality to allow a vendor's field support representatives, depending on permissions granted by the administrator, to login to the licensing server 82 to create a secure client session 74, setup and maintain field support representatives and regions, setup and maintain customers and field support contacts; create and execute sales reports from the licensing database 49; and issue demonstration or trial licenses.

The field support option 71 may be adapted to display a user-level view of the database 49 that allows the vendor's 40 field support staff to review user 30 history, identify user 30 leads, and provide product samples to prospective users 30. The field support option may include access to multiple predefined reports, such as product reports (i.e., name, version, license type, etc.), sales reports (i.e., sales by user, product, region, etc.), and user status reports (i.e., issued licenses by term, product level, termination date, etc.).

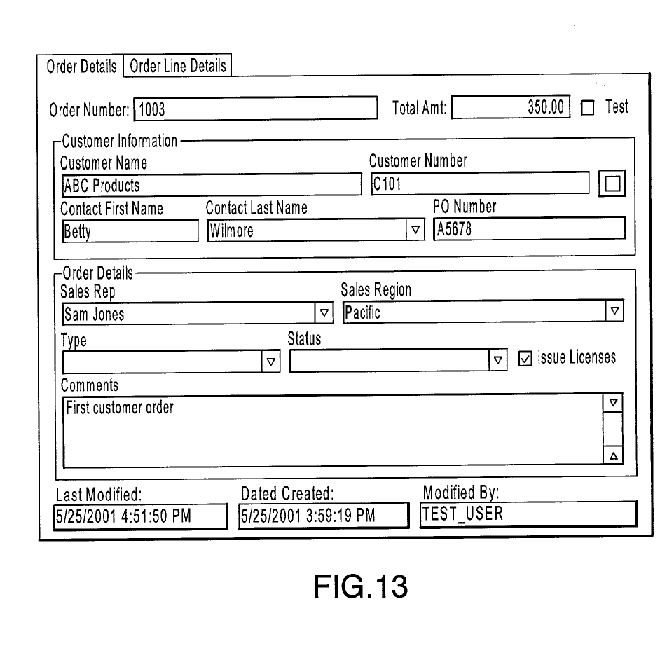

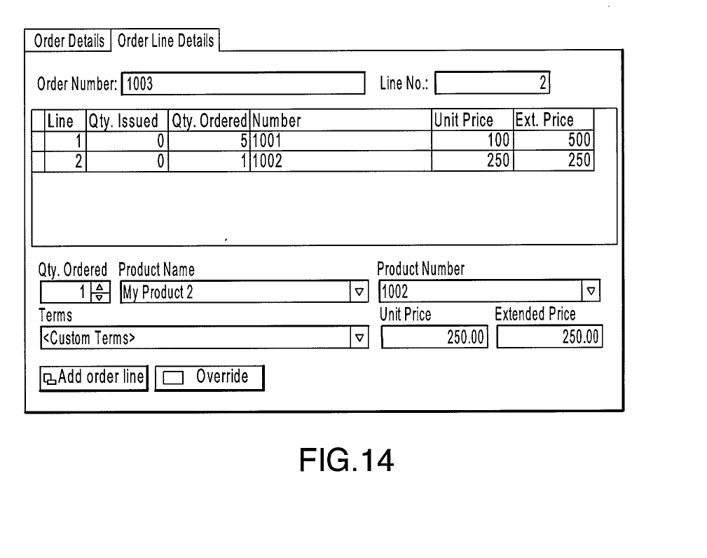

Yet another operational mode of the access tool may include an order fulfillment option 69 as shown, for example, in FIG. 13 and 14. The access tool with the order fulfillment option 69 allows a vendor's order fulfillment department to manage orders by login to the licensing server 82 to create a secure client session 74; setup and maintain user and order contacts; entering and approving orders; issuing licenses to fulfill orders; creating and executing order and accounting reports from the licensing database 49; and generating license usage reports for users. The order fulfillment option may be adapted, in one exemplary embodiment, to display another user-level view of the database 49 that provides, for example, access and permission to record and/or track user 30 orders.

In addition to the access tool, the client installation program may also include a dynamic link library (e.g., DLL) 86, which, in one exemplary embodiment, may be implemented as a shell namespace extension. The DLL 86 may be packaged with the completed software application 83 and installed with the application on the user 30 machine. The DLL 86 may, inter alia, extend the user interface of, in one exemplary embodiment, the Windows Explorer 87 to provide a central location for users 30 to manage their licenses. The DLL 86 may be adapted to present licensing information for SLS protected applications in, for example, a hierarchical format with a root file folder architecture thereby providing the user a high-level view 88 of the user's current licensing portfolio. This view 88 may contain, for example, information from the root folder 89 showing machine ID information for the system, the size and status of a datastore 91 that may be optionally encrypted, and total counts of current licenses, licenses about to expire, and expired licenses. The file folder view 88 may also contain information for licensed software obtained from various vendors, along with sub-folders displaying, for example, base product information.

With reference now to FIG. 17, an e-commerce solution, in accordance with one exemplary aspect of the present invention, may be implemented as a distribution system, wherein a software vendor 40 interested in becoming a partner with a distributor 25 may enter into an agreement (step 102) to assign to the distributor 25 the responsibility for electronically marketing and licensing software applications developed by the vendor 40. When the agreement is completed, the distributor 25 sends a “toolkit” to the vendor 40 (step 106). In one embodiment of the present invention, the toolkit contains: a license manager module which may include, for example, a Java Runtime environment and a Java program that handles interactions between the licensing application programming interface, the website, and the user; at least two versions of the licensing software library, at least one test version and one real version; and information manuals in, for example, Adobe Acrobat PDF format. The software libraries may be distributed as static libraries and the manuals may include a licensing API reference and a licensing overview. The toolkit allows the vendor 40, inter alia, to make modifications to the software application in preparation for distribution over the Internet 35 (step 110). Multiple versions of the software library included in the toolkit allow the vendor 40 to test the modifications and help correct functionality. The license manager provided in the toolkit, further described hereinafter, acts, for example, as a simulator to aid the vendor 40 in testing the software application with the modifications and additions. Modifications may include, for example, taking out existing licensing information, adding distributor-provided licensing information, adding or removing product levels and options that can be included in the application. The level and option selections become part of the subscription information and play a part in determining the cost of the subscription. The level and option information the vendor programs into the software application may be displayed to the user 30 via, for example, a distributor webpage. The license manager provided in the toolkit gives the vendor 40 the ability to simulate the user display and determine what options and levels should be allowed. The vendor 40 can also include in the software the option to use the application on a trial basis or on a subscription basis.

A version ID may also added to the software application to allow vendors 40 to upgrade their applications in the field without necessarily invalidating current user licenses. For example, a user 30 downloads a particular version of the application and the version ID from the application is stored in, for example, a license file described infra. When the license is renewed, the current version ID of the application may, for example, be compared with the version ID in the license file. Pricing information may include vendor prescribed actions in the case where the version ID's do not match. For example, the vendor 40 may incorporate into the pricing information the ability to allow the user 30 to continue paying the same price for the new version, or the vendor 40 may alternatively require the user 30 purchase an upgrade license for the new version. The vendor may also optionally require the user 30 to obtain the newest version in order to complete the renewal process.

The software code provided in the toolkit may also include licensing application programming interface (API) calls which are substituted during the wrapping process with a final version of the licensing API code provided by the distributor 25. This code may, for example, run security checks when the vendor software is running on the user computer 30 and contributes to the overall security that the distributor provides for the vendor software application. In accordance with one embodiment of the present invention, the software code, provided by the distributor and integrated by the vendor 40 into the software application, allows the distributor 25 to add appropriate anti-piracy and tampering checks during the wrapping process described herein. This, inter alia, reduces the vendor's responsibility for spending additional time and/or resources to engineer the appropriate security measures in each software application. In addition, the present invention reduces the vendor involvement in security violation issues and transfers the responsibility to the distributor or to the security technology provider.

In another exemplary embodiment, at least two calls may be included in the initialization of the vendor software for invoking distributor code and performing security checks. Calls to the distributor code may also be placed by the vendor 40 at strategic locations throughout the software. The vendor 40 can add a call to invoke the licensing API code and a call that will perform a security check against the licensing information. The software may be tested using the toolkit's test version of the licensing calls and the licensing manager. When the testing cycle is complete, the vendor 40 may re-link the software with the original version of the distributor software provided in the toolkit. Any method of re-linking the software, now known or hereafter derived by those skilled in the art, may be used. The distributor software provided in the toolkit is substituted, for example, with the actual licensing API code during the wrapping process. By not providing the final version of the licensing code, the distributor 25 maintains security and proprietary security of the code, which otherwise could be compromised or unwittingly passed on to a potential hacker if provided to the vendor in the toolkit. Moreover, allowing the vendor 40 to integrate the licensing calls in-house reduces potentially unwanted exposure to the vendor's intellectual property.

Alternatively, the vendor 40 may choose to leave existing licensing mechanisms in the application in which case the software application itself is not encrypted. The wrapping program adds code to handle licensing detail and only the licensing code provided by the distributor 25 is encrypted. The existing licensing structures in the application (i.e., FlexLM, etc.) may be adapted or otherwise configured as standalone structures. If the vendor 40 chooses to leave existing licensing structures instead of incorporating the distributor licensing code, the product may be alternatively distributed in a less secure format.

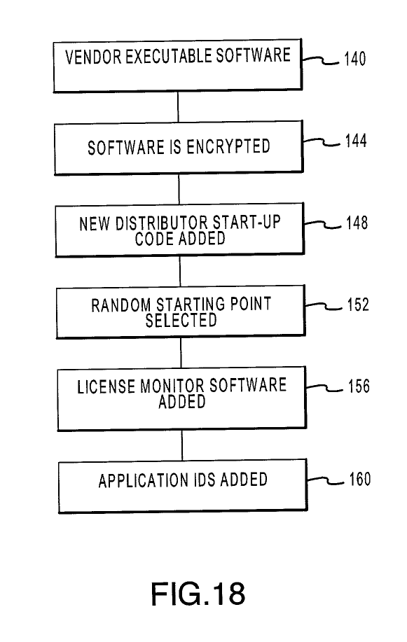

Once the software application has been modified, the vendor 40 provides an executable version of the software application 83a to the distributor 25, wherein “executable” means that the application has been compiled with the code provided in the toolkit and it has been converted from source code to object code containing machine code instructions. If the vendor 40 chooses, this exchange of code can take place over, for example, the Internet 35; however, other data mediums, such as, for example, CD-ROMs, DVDs, VCDs, can be used to provide further security. The distributor 40 then wraps the software application, described infra, and gives it back to the vendor 40 to incorporate into an install program. The vendor 40 then gives the completed version back to the distributor 25 to be made available, for example, over the Internet 35 (step 140 of FIG. 18).

In an alternative embodiment where the vendor 40 is also the distributor, it may be left to the vendor 40 to integrate licensing information and protection code into the software application. This may be accomplished by using script builder and wrapping tools 78 supplied with the SLS (82 and at least one of 67, 68, 69, or 71) and accessed with the developer option of the access tool 67. In order to use these tools, the vendor 40, in one exemplary embodiment, purchases the developer option with the SLS (82 and at least one of 67, 68, 69, or 71). The script builder 78 provides, inter alia, the functionality to integrate, for example, licensing information into the software application 84 using, for example, a scripting language. Together, these tools may support creating, implementing, debugging and applying customized scripts. The script builder 78 is used, inter alia, to create scripts for the licensing of the software application 83 (i.e., client side scripts) and/or scripts for the license server 82 (i.e., server side scripts). The software licensing scripts may be used, for example, to obtain user information, to instruct the user how to obtain a license, and/or to inform the user of the license status for a particular application. The license server scripts may be used to update the database 49, generate valid licenses for a particular user, access information about a particular product, access security information for a user, access general user information, and/or access sales representative information. In one embodiment, the client-side scripts interact with the wrapped application 83 using, for example, global functions and events. The SLS (82 and at least one of 67, 68, 69, or 71) may be adapted to provide default client and server scripts to deliver “out-of-the-box” rapid deployment. Additionally, the script builder 78 may be used to permit the vendor 40 to provide specific and unique information or services for the user. Accordingly, a preferred embodiment of the present invention offers substantial advantages in that the SLS (82 and at least one of 67, 68, 69, or 71) is extensible and may be customized to fit and grow with the needs of the user. That is to say that the SLS does not constrain the user to use “out-of-the-box” functionality, but such “out-of-the-box” functionality is made available for those users desiring a “plug-and-play” solution.

Modification of a script may include, for example, adding additional fields for obtaining user information. The database 49 may also be modified with the same or similar fields if more fields are added. The script builder also may optionally include a form builder (i.e., a dialog editor) tool used to create custom dialogs by, for example, allowing dialog fields to be scripted from within the script builder 78. The script builder 78 may be adapted to provide, for example, a debug environment that permits the setting of breakpoints, watching program variables, setting of licensing object variables, and/or checking of script execution.

In yet another exemplary embodiment, after construction of the scripts, the vendor 40 wraps the client script, information about the server script and/or other information around the application using the wrap tool 78. The wrapping tool 78 allows information to be specified, such as, for example: vendor ID, product ID for the application, server name and port number, server licensing script, client licensing script, header script, application file name and location, and wrapped file name and location. The wrapped application 83a may be optionally configured not to run a script on application invocation, which may be used when the vendor 40 desires to have licensing checks derive directly from the application instead of the script. If, for example, no script runs and the application does not check licensing, the wrapped application will not be deemed to be secured from unlicensed use but will be secured from, for example, tampering. After the protected application is generated, it may be packaged with, for example, a client license management install program 94 or any other component the vendor 40 deems appropriate, into a integrated product 92 adapted to be distributed to users 30. In another exemplary embodiment of the present invention, the client license management install program 94 may additionally install a client license management DLL onto the user's system 30.

With respect to an exemplary embodiment for the protection of executable code 83a, in accordance with one aspect of the present invention, once the distributor 25 has received the executable version 83a of the software application from the vendor 40, modifications may be made to the executable file (step 110 of FIG. 17) to allow the distributor to protect and monitor the use of the software. In one embodiment of the present invention, this process is referred to as “wrapping” (step 114 of FIG. 17) and may be accomplished by code injection or by other alternative mechanisms now known or hereafter derived by those skilled in the art.

The wrapping process is comprised of, for example, a wrapping tool the distributor 25 uses to: compress and/or encrypt the software application; add a software module to check for valid licenses and tampering; add new start-up code and change the starting address to point to the new code; and add ID's to identify the software application. The present invention provides, inter alia, an encryption utility (step 144 in FIG. 18) using, for example, any encryption method now known or hereafter derived by those skilled in the art. The encryption process, in one preferred exemplary embodiment, is a standard encryption process such as DES or RSA.

During the wrapping process, vendor start-up code may be replaced with distributor start-up code (step 148 in FIG. 18). In an exemplary embodiment of the present invention, the distributor start-up code becomes part of the key for decrypting the software application and the licensing code. Moreover, in a preferred exemplary embodiment, the decryption key is stored with the software application itself and not at a remote location. The present invention also provides security features, such as, for example, random codebase offset entry points and other methods known in the art to subvert attempts to hack, crack or otherwise decompile and/or access executable code. Specifically, during the wrapping process, a random codebase offset entry point may be selected in the start-up code (step 152 in FIG. 18) which can be changed, for example, each time an application is wrapped. Accordingly, since the start-up code may be altered for each instance of a wrapped application, the code is less susceptible to being compromised. In another exemplary embodiment, during the decryption process on the user computer 30, the start-up code, used as the decryption key, performs a hashing algorithm on each byte of code as it is decrypted and creates a checksum table in memory to provide further security.

In another embodiment of the present invention, a software module, referred to as a license monitor, may be added to the application during the wrapping process, (step 156 in FIG. 18) to enable the distributor 25 to check for piracy attempts at the user site. The license monitor is initialized, for example, by the start-up code running as a thread or, in other words, as an independent sub-process of the main program process which shares the same memory space.

As the start-up code begins the decryption process, the license monitor may be decrypted first. The start-up code then performs a CRC or MD5 checksum calculation on the program code stored in memory. This checksum may be compared against the value that was computed and injected into the program when the program was wrapped. If the values do not match, the decryption process may be halted before the software application is decrypted which helps further protect the security of the vendor's software application.

In another embodiment of the present invention, the API calls installed by the vendor 40, with the aid of a toolkit, may be substituted with, for example, distributor-created software routines, or licensing API calls, during the wrapping process. These API calls provide information to the license monitor to perform security checks before the application initializes and while the software application is running in memory. In an exemplary embodiment of the present invention, after the license monitor has been decrypted and initialized by the start-up code, the license monitor begins performing further security checks on the software application. The inclusion of distributor code to monitor security assists the distributor in maintaining control and responsibility for tampering and piracy attempts, while generally reducing the allocation of additional vendor resources to that function. Moreover, if users 30 have licensing issues, the distributor 25 may be contacted directly rather than the vendor 40.

In order to uniquely identify the vendor software application, application ID's may be injected into the application code by the wrapper program (step 160 in FIG. 18). In an exemplary embodiment of the present invention, the application ID consists of a partner ID which is, for example, eight characters; a product ID which is also, for example, eight characters and which is unique for each product under a partner ID; a level ID which is, for example, two characters and allows, for example, sixteen levels for each product; an option ID which is, for example, eight characters and allows, for example, thirty-two options per product. In one exemplary embodiment of the present invention, this unique number becomes part of the start-up code and may also become part of the key used in the decryption process which adds additional security protection since the application will not decrypt properly if the ID's are altered. The application ID for each software application may also be stored in a database that is accessed by, for example, a webpage server, thereby allowing a webpage display of software applications available for downloading. Once the wrapping process is complete, the wrapped software includes the vendor software application, the distributor licensing code, the license monitor, and the start-up code which also includes the application ID's. The wrapped software may then be returned to the vendor 40 to be added to the vendor install program 92 (step 118 in FIG. 17). In an alternative embodiment, where the vendor is also the distributor and the vendor has purchased the SLS (82 and at least one of 67, 68, 69, or 71) from the distributor, the distributor for the SLS (82 and at least one of 67, 68, 69, or 71) does not have to do anything further to the vendor software.

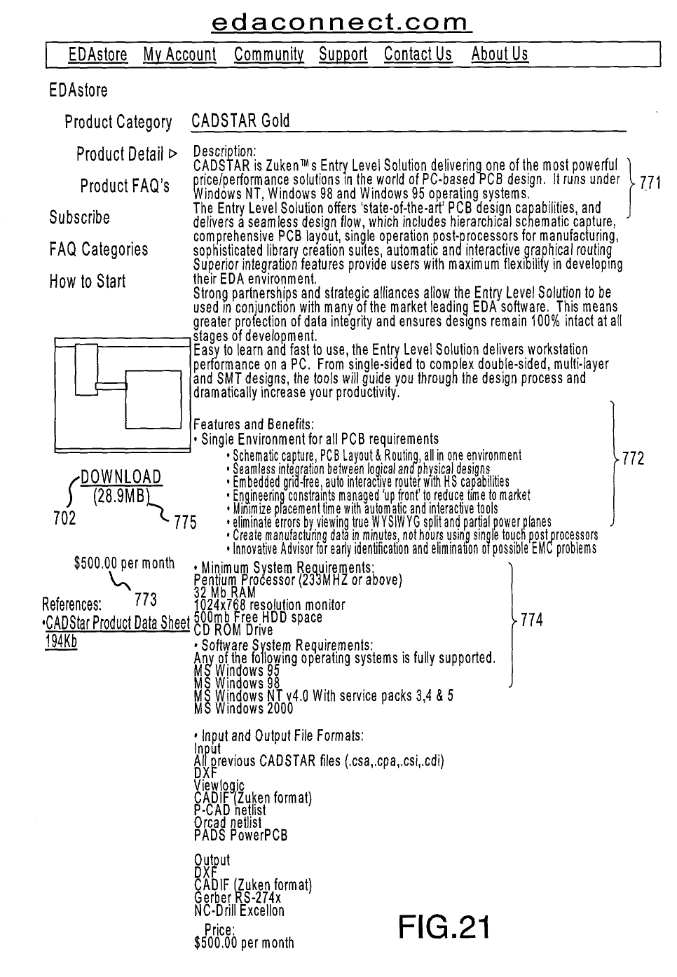

As mentioned supra in accordance with one embodiment of the present invention, the software application is given a unique ID which may be stored in a database on the distributor's web server. After the software application has been added to an install program 92 and returned to the distributor 25, it is added to, for example, an electronic store (step 122 in FIG. 17) via the web server and made available for downloading to user computers 30. When a user 30 loads and views the website information, the screen displays a list of vendors 401, along with a list of categories of available software applications 402. After a user 30 selects one of the categories 402, the system displays a list of the actual software applications 504 that can be downloaded to the user computer 30. After the user 30 selects one of the applications 504, the system displays (as shown in FIG. 21), for example, a brief description of the software 771, available features and options 772, subscription pricing information 773, system requirements 774, the size of the file 775 and/or the like.

Alternatively, the distributor 25 may create a webpage specifically for a particular vendor 40 which is accessible by the user 30. In another exemplary embodiment, if a vendor website exists, the vendor webpage may include a hyperlink to the distributor webpage. As such, a user browsing the vendor website could select the hyperlink to the distributor webpage and be able to view a customized version of the software applications available. In an exemplary embodiment, the displayed webpage shows only the software applications for that specific vendor. Yet, consistent with an exemplary embodiment of the present invention, the distributor 25 would provide the security and marketing of the software applications added to the electronic store.

Also, the distributor 25 can provide links to individual vendor websites or contact information for a vendor 40 that offers a particular service.

In an alternative embodiment, where the distributor 25 provides the vendor 40 with the SLS (82 and at least one of 67, 68, 69, or 71), the vendor 40 may be responsible for the distribution of the protected software applications. The distributor can provide the SLS (82 and at least one of 67, 68, 69, or 71) over the internet or by means of a CD or any other data medium now known or hereafter derived by those skilled in the art. The vendor 40 may then distribute the applications over, for example, the internet, intranet, CD or any other data medium now known or hereafter derived by those skilled in the art.

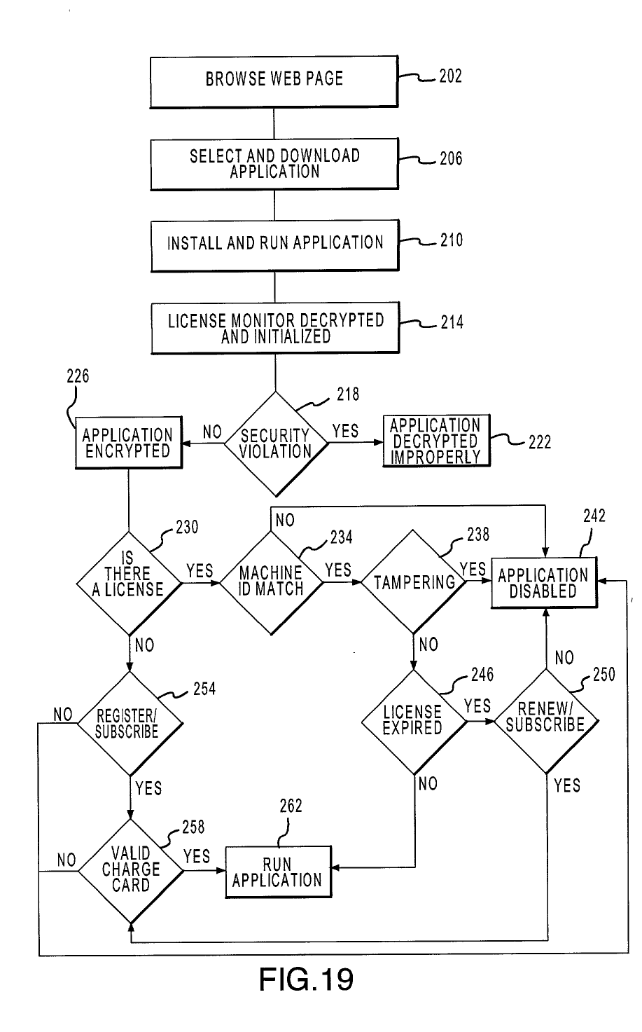

After the software application has been added to an electronic store by the distributor 25, the user 30 may then download the application to the user computer 30 (step 126 of FIG. 17). With reference to FIG. 19, an exemplary data flow associated with the downloading of a particular software application between a user computer 30 and a distributor server computer 25 is shown. In one embodiment, user 30 begins the process by engaging a browsing session (step 202 of FIG. 19), where pages may be downloaded from the distributor via, for example, an Internet browser such as, for example, Netscape, Microsoft Internet Explorer or any information client now known or hereafter derived by those skilled in the art. As described supra, FIG.'s 5-7 depict exemplary screenshots which may be viewed by the user 30. The user 30 can select a software application from a displayed list of applications. User 30 then selects the software application to be downloaded (step 206 of FIG. 19) by using a mouse, or any other input device now known or hereafter derived by those skilled in the art and associated with the computer to select, for example, a control embedded within the screen page indicative of the item to be downloaded. The application to be downloaded may thereafter be selected, for example, by clicking on the associated control as shown in FIG. 21 where the user 30 may select the word ‘Download’ 702. The distributor computer 25 then suitably downloads the selected software application as an executable file to the user computer 30 by methods generally well known in the art.

Alternatively, a shopping cart method may be used to select software applications wherein all selected applications are downloaded when the user ‘checks-out’ the shopping cart. Any shopping cart methods of selecting items from a webpage well known in the art may be used.

In an exemplary embodiment of the present invention, another software module, referred to as a license manager, may also be downloaded to the user computer 30. This module, which in one embodiment acts as a simulator in the toolkit, is provided by the distributor to, inter alia, facilitate interaction between the user computer 30 and the distributor web server 25. License manager software may optionally include a Java runtime environment and/or a Java applet that handles interactions between the license monitor, the website, and the user 30. Appropriate licensing API calls may initiate the license manager to begin, for example, a browsing session with the distributor web server 25. In one embodiment of the present invention, obtaining a license file for the first time causes the license manager to begin a browsing session.

After the user 30 has downloaded a copy of the software application, the user 30 may then install the application. In one exemplary embodiment, when the user 30 runs the application, the license monitor, added during the wrapping process, is decrypted in RAM and then initialized (step 214 of FIG. 19). The software application itself may then be decrypted and decompressed in RAM by the start-up code (step 226 of FIG. 19), thereby avoiding a temporary, insecure location. As the decryption/decompression algorithm runs, various randomized and un-randomized sections of code may be mathematically evaluated using, for example, CRC or MD5. The resulting one-way function value may then be stored, for example, in a checksum table in memory, along with the codebase offsets within the memory image on which such a calculation was performed.

A security check may optionally be included in the start-up code and performed on the license monitor, for example, before the software application is decrypted. A checksum evaluation may be performed on random parts of the license monitor code to determine if tampering attempts have occurred. In a preferred exemplary embodiment, if tampering is detected, the decryption process terminates. Moreover, as the software application itself is being decrypted by the start-up code, as one of the security checks performed by the license monitor, a debugger running, for example, during the decryption process may be detected and interpreted as a security violation. In an exemplary embodiment, if a security violation is detected, the license monitor will allow the decryption to continue, but will cause the application to decrypt incorrectly, thereby prohibiting the application from running correctly (step 222 of FIG. 19). Therefore, in an exemplary application of the present invention, security is maximized throughout the decryption process as well as at run time.

In another exemplary embodiment of the present invention, the license monitor performs additional security checks while the application is running in memory. Although the license monitor may not be continuously active while the application is running, it may be activated by, for example, licensing API calls that are incorporated by the vendor 40 and substituted with distributor code during the wrapping process. By adding these calls throughout the software application, the vendor 40 substantially increases the amount of security the distributor 25 is able to provide. When the license monitor is not inactive, it generally stays dormant for a semi-random amount of time to minimize CPU usage; however, when activated, it performs CRC, MD5 calculations, or the like, on data stored in, for example, the checksum table in memory. If the values do not match, it may be assumed that piracy attempts have occurred and the license monitor will disable the application prohibiting further use. Alternatively, a TCP/IP socket can be opened broadcasting the attempted protection violation. Also, the vendor 40 integrated calls may activate the license monitor to perform various checks using the license file described infra.

In an exemplary embodiment of the present invention, before an application can be executed, the license monitor may communicate, for example, with the licensing API to determine if a license has been obtained for the application (step 230 of FIG. 19). When a license has been obtained, the license information may be stored in a file designated a “license file”. In a preferred exemplary embodiment, an XML format may be used to obtain the desired information for the license file. Active server pages (ASP) may also be created using VBScript, SQL, ActiveX Data Object, XML and the like. ASP may then used to retrieve and store data in the database. While the present invention suggests the use of an XML format to represent the data in the license file, other formats can be used such as, for example, extensible style language (XSL), hypertext markup language (HTML), standard generalized markup language (SGML), or other formats now known or hereafter derived by those skilled in the art.

In yet another preferred exemplary embodiment of the present invention, the license file contains information such as, for example, the machine ID for the user computer 30 running the application, name of the product, product number, license type, expiration date, options, level, version ID, and/or a digital signature. The digital signature may be added to the license file, for example, by using the MD5 algorithm. MD5 is well known in the art and is typically provided as a utility in Java development kits for verifying the authenticity of a signature and associated data. In one exemplary aspect, the digital signature can provide security against a user modifying the machine ID in an effort to permit the application to run on an unlicensed machine and may also guard against a user 30 getting an unlimited number of free trials. The machine ID may be generated from various configuration parameters associated with a fingerprint of the user computer 30 (i.e., OS and version, machine name, etc.) which may be stored in the license file.

If the license file does not exist on the user computer 30, the license monitor can be configured to initialize the license manager to communicate with, for example, the website. Moreover, the database on the distributor computer 25 may be checked by the license manager to determine if a license file exists. If a license file is found not to exist on the database, information may be provided by the user 30 to create a license file which is capable of enabling the application to run (step 254 of FIG. 19).

In an exemplary embodiment of the present invention, the license manager communicates with the website to obtain, for example, the appropriate webpages for guiding the user 30 through an appropriate process to input information. In an exemplary preferred embodiment of the present invention, the vendor 40 incorporates the terms of use into the software application which will instruct the user 30 whether the license can be given automatically for use on a free trial basis or the license can be purchased on a subscription basis with, for example, a credit card (step 258 of FIG. 19) for a set period of time via any electronic commerce server now known or hereafter derived in the art.

Alternatively, the software application may be purchased on a substantially permanent basis, in which case user 30 may use the purchased version of the software application in perpetuity. Those skilled in the art will appreciate that other payment methods may be used to complete the purchase such as, for example, purchase orders, pre-paid accounts, bank drafts, etc. In an exemplary aspect of the present invention, the user 30 may select one or more payment types from the displayed webpage and provide the appropriate information.

The time period for the subscription, as determined by the vendor 40, may be any length of time (i.e., hourly, daily, weekly, monthly, etc.). The terms are preferably part of the pricing information the vendor 40 adds to the application using the toolkit provided by the distributor. The license monitor evaluates the information and instructs the license manager what information is needed, thereby allowing the license manager to display the appropriate screens. In an alternative exemplary embodiment of the present invention, a user 30 can be charged on a usage-based model.

The present invention allows, inter alia, the user 30 to acquire desired software applications via, for example, the Internet 35. Accordingly, an exemplary electronic store embodied in a webpage is not merely a catalog where the user establishes contact with the vendor to wait for the software to be delivered; but also, the user is given substantially immediate access to the software displayed. Alternatively, if the software application is large and the user 30 does not have access to a high-speed connection such as, for example, a T1 or DSL, the software can be sent to the user 30 in the form of a CD or any other data medium now known or hereafter derived by those skilled in the art.

In an exemplary embodiment, after the user information has been sent to the website, a license file is sent back from the website to the user computer 30 via the license manager which allows, inter alia, the software application to run after the appropriate checks have been performed by the license monitor. The license file may be stored in a pre-determined location on the user computer 30 and, as previously described, the license monitor may be adapted to perform various checks using information obtained from the license file. For example, one such check may determine if the machine ID in the license file matches the machine ID of the computer running the application (step 234 of FIG. 19). The machine ID for the user computer is generated from scratch each time a license file is checked. The newly generated machine ID is compared with the machine ID stored in the license file. If the machine ID's do not match, the application may be prevented from executing (step 242 of FIG. 19). If the machine ID's match, the license monitor determines if any tampering has occurred by evaluating the results of the checksum table in memory (step 238 of FIG. 19). If tampering has occurred, the application may be disabled (step 242 of FIG. 19). The license monitor may also be configured to check to determine if the subscription period or free trial period has expired (step 246 of FIG. 19). If the trial period has expired, the user 30 may be queried to begin a new subscription or the existing subscription may be automatically renewed (step 250 of FIG. 19). Other checks may be performed at this time depending on the terms, option, and level information selected by the user 30 during the subscription process and included by the vendor 40 in the licensing code. If all checks performed by the license monitor are valid, the software application may then be allowed to run (step 262 of FIG. 19).

Generally, the renewal process for software applications can be time consuming. The user 30 may contact the vendor 40 to renew a subscription and then wait for unlock codes to be provided. In contrast, the instant exemplary embodiment of the present invention may be adapted to allow the renewal process to occur automatically, in the background, without any intervention, or with minimal intervention, from the user 30. One of the checks performed by the license monitor may be that of an expiration date check. If the license monitor detects that the current date matches or postdates the expiration date, the license monitor may initialize the license manager to contact, for example, the web server. A new license file may then be generated with substantially identical or similar user information, machine ID and a new expiration date. The new license file may then be stored in the database 49 and the license manager may copy the file to the user computer 30. A charge may then be made to the user and a receipt, for example, e-mailed to the user 30. If the user 30 no longer desires the subscription, the user 30 may go to the distributor website 25 and select cancellation of the subscription. However, in an exemplary preferred embodiment, the subscription continues to be automatically renewed until it is cancelled by the user 30. Once the user 30 has cancelled a subscription, data remains in the distributor database to allow the subscription to be reactivated by the user 30. In the case where a user has cancelled a subscription and a new version of the application is available at the time user 30 decides to reactivate the subscription, the user is given the choice to use the old version or upgrade to the current version.

In an alternative exemplary embodiment, the present invention can be used to provide software applications in a corporate setting with multiple users. The corporation can employ a procurement office model, such as a cost center or user group, with an administrator in charge of procuring the appropriate software applications. The administrator may be made responsible for interfacing with the distributor website 25 and completing the subscription process for the desired software applications. Since the application security features are machine dependent, the administrator provides the correct machine ID for each application subscription. If one software application is to be run on several machines, the administrator completes the subscription process for each machine. The license file for each application may then be copied to a pre-determined directory on, for example, an intranet server behind a firewall. The user 30 then copies the license file to the appropriate user computer 30. The license file may also be sent via e-mail to the user 30. Alternatively, the application can be downloaded from any other medium, such as, for example, a CD or any data medium now know or hereafter derived by those skilled in the art.

In another exemplary embodiment, when the application is run, the license monitor uses the information contained in the license file to execute the security checks. If the checks are successful and the machine ID's match, the application runs without the user 30 having to provide any information to the distributor 25. As previously described, the application can be purchased on a substantially permanent basis or on a subscription basis. In the case where it is a subscription basis, the administrator specifies that the license file automatically generated at renewal time be sent to the appropriate user via, for example, e-mail. If the individual users in the corporation do not have appropriate access to the network, the software application may be downloaded to the appropriate server on the intranet and copied to the appropriate user computer 30. In a preferred exemplary aspect, the administrator is responsible for managing subscriptions. Details of each subscription may be viewed by the administrator on an account detail screen, for example, described below. This screen may be printed and used as a report/record of transactions conducted with the distributor 25 and used to provide status information for subscriptions.

In an alternative embodiment, where the vendor 40 uses an SLS (82 and at least one of 67, 68, 69, or 71) purchased from the distributor 25 to integrate licensing information and security measures, the vendors 40 can create their own website and user interface to allow the user 30 to browse and select a software application. Installing a protected software application on the user machine creates several components: the user 30 has a protected application where the application code and most of the data are encrypted and where startup and tamper-protection code, scripts that define the licensing user interface, vendor ID's, product ID's, vender server names and port numbers, server-side script names, and reference to the client license management DLL have all been added to the application.

In a preferred exemplary embodiment of the present invention, user 30 may acquire the client DLL 86 after application installation shown, for example, in FIG. 2. The DLL 86 stores, for example, the license information for the protected applications 83 in an encrypted file called the datastore 91. Protected applications may make licensing checks by calling a hidden codebase offset entry point in the DLL 86. The client DLL 86, inter alia, runs the script which has been added to the software application 83 which calls the license management service on the vendor's 40 licensing server 82, which communicates with the database 49 to obtain a license. The client DLL then stores the license in the datastore 91 created on the user machine and communicates the results back to the protected application 83. The results are encrypted using, for example, a time-dependent encryption scheme which prevents the attempt by the user 30 to create a version of the client DLL 86 to bypass the licensing process. Other security methods now known or hereafter derived in the art may also be employed to subvert attempt to bypass the licensing process.

In another exemplary embodiment, the user 30 may also have an encrypted datastore 91 after installation. License data is stored in the datastore 91 as, for example, a physical file on the user system 30. The datastore 91 may be configured or otherwise adapted to contain other information for the detection and prevention of copying the datastore 91 file to another system; setting the system clock back in time to attempt to extend the license duration; and/or manually altering the datastore 91 to grant/extend licenses. As a result of the datastore 91 residing on the user 30 machine, network or Internet access 35, for example, is needed only when the user acquires a new license or performs some function requesting access to the vendor's licensing server 82.

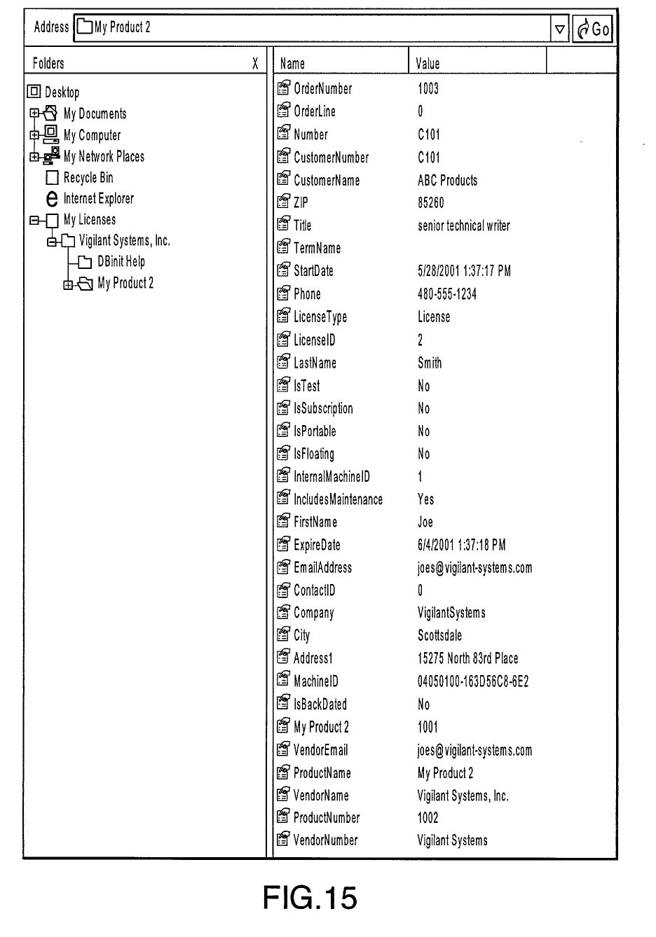

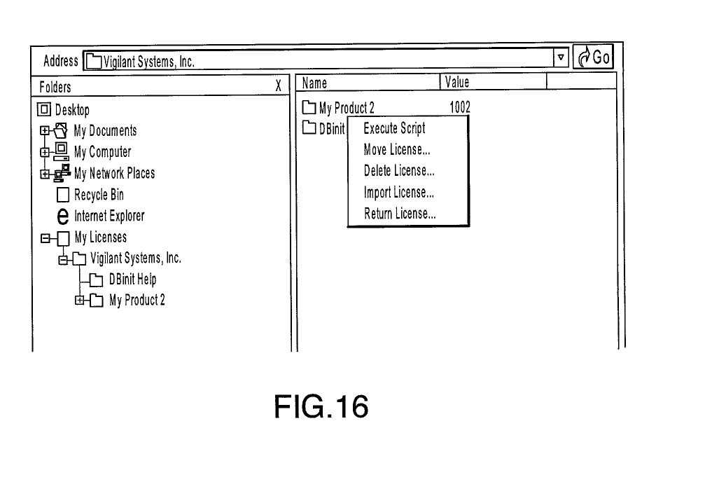

User 30 also may be provided with a modified Windows Explorer 87 user interface after installation as shown, for example, in FIGS. 15 and 16. The client license management DLL 86, in a preferred exemplary embodiment, is adapted to extend the user interface of Windows Explorer 87 to provide a central location for users 30 to manage their licensing information without having to run each of the licensed applications. The client DLL 86 may be further configured to present licensing information for the protected applications 83 in, for example, a hierarchical format 88 with a root file folder 89. The client DLL 86 may also further be adapted to integrate with Windows Explorer 87 giving customers a familiar user interface to perform, for example, the following functions: (1) allow users to import a license that was emailed to them and add it to the datastore 91; (2) display the status of licenses on the system and the system's identifying machine ID; (3) remove a license from the system; (4) move a license, subject to vendor-defined terms, from a first system to a second system; (5) execute a licensing script for a protected application 83; (6) obtain an updated license from the vendor's licensing server 82; (7) display information about a license including, for example, start date, expiration date, vendor ID, product ID, and product options available and/or licensed, etc.

In another exemplary embodiment of the present invention, in order for the user 30 to run the application, a license may be obtained through the registration or subscription process (step 128 in FIG. 17). In a preferred exemplary embodiment, licensing code integrated in the software application by the vendor 40 helps determine if the downloaded application can be used on a free trial basis or if a subscription is first obtained. If it is a free trial, the user 30 completes the registration process, for example, by providing information to the distributor 25 to obtain an automatic license. Registration information preferably includes, for example, a user name, company name, business e-mail, the software application number and name. In yet another exemplary embodiment, applications offered on a free trial basis will not require payment information and, accordingly, a new account will not be created. As part of the information given to the distributor 25, the machine ID for the current user computer 30 may be provided substantially transparently by the license manager using aspects of the hardware configuration and the operating system. Information from the registration information and machine ID may then be added to the license file created, for example, on the web server.

Of particular relevance to the instant embodiment of the present invention is the ability of the recipient, in this case the distributor computer 25, to extract from the HTTP request header, the IP address of the source computer and a machine ID for the source computer, i.e. the user computer 30. Any other transfer protocols, now known or hereafter derived by those skilled in the art, that allow the recipient to extract the sending computer's network address may also be used.

Once the registration process is complete, the license manager performs an HTML post operation to send the registration information back to the website to retrieve the license file. The license manager performs this, and other operations, for example, in response to API calls made by the application. After the appropriate checks are successfully completed by the license monitor using the information in the license file, the application may then be permitted to run. In an exemplary aspect, the expiration date for the free trial may be predetermined by the vendor 40 and the application will run until that date. When the authorized term expires, the license monitor initializes the license manager with an API call and displays the appropriate webpages allowing the user 30 to obtain a new license through the subscription process. If the user 30 does not obtain a subscription and a new license file, the licensing API calls will return an “expired” status back to the application which will then terminate after displaying an error message to the user 30. In addition, the licensing code is able to determine if the current date on the user computer 30 has been altered in an attempt to artificially extend the free trial. Other security countermeasures now known or hereafter derived by those skilled in the art may be used to subvert attempts to bypass the expiration date feature.

If the application is alternatively not provided on a free trial basis, the user 30 may obtain a license for the software application by completing the subscription process. As with the registration process, when the subscription process is completed, the license file created on, for example, the website is retrieved by the license manager. After the appropriate checks are successfully run by the license monitor using the information in the license file, the application is then allowed to run (step 132 of FIG. 18). As mentioned previously, a permanent license to use the software application may be purchased. In the case where a vendor 40 does not have access or the resources to create a website, the distributor 25 can market the software applications for that vendor 40.

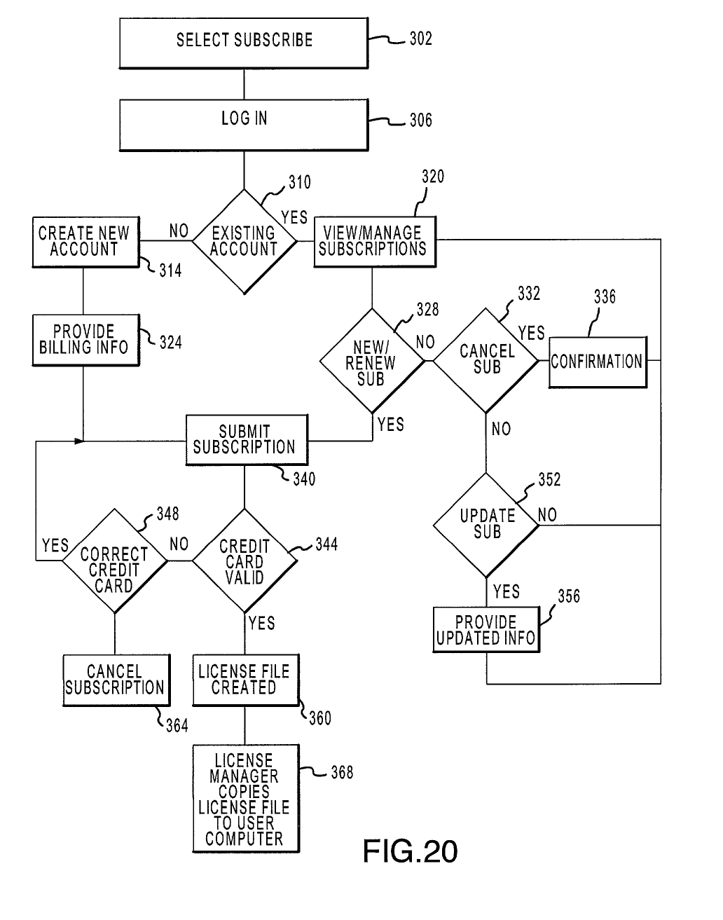

FIG. 20 illustrates an exemplary flow chart of the subscription process. The subscription process may be initiated by the license monitor or by selecting “subscribe” from the webpage. FIG. 20 shows the process initiated by the user selection. Even though the process may be initiated in a variety of alternative methods, the data flow is generally the same. After subscription has been selected (step 302), the user logs in (step 306) which involves accessing the database residing within, for example, the distributor's web server 25. Login preferably involves user 30 entry of a username and password previously acquired during a subscription process. Additionally, this login step may be performed using password and username information retrieved from the database, thereby streamlining the process for the user 30.

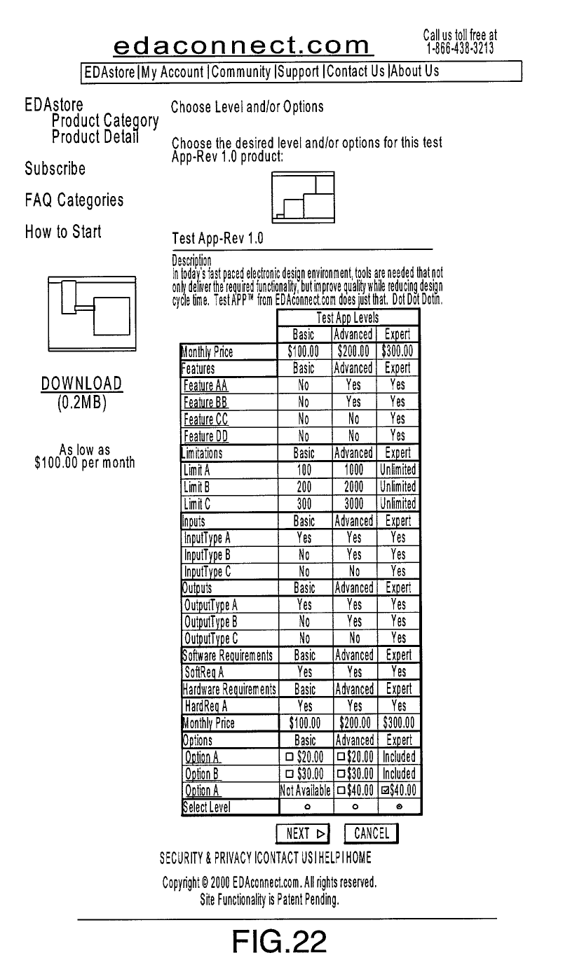

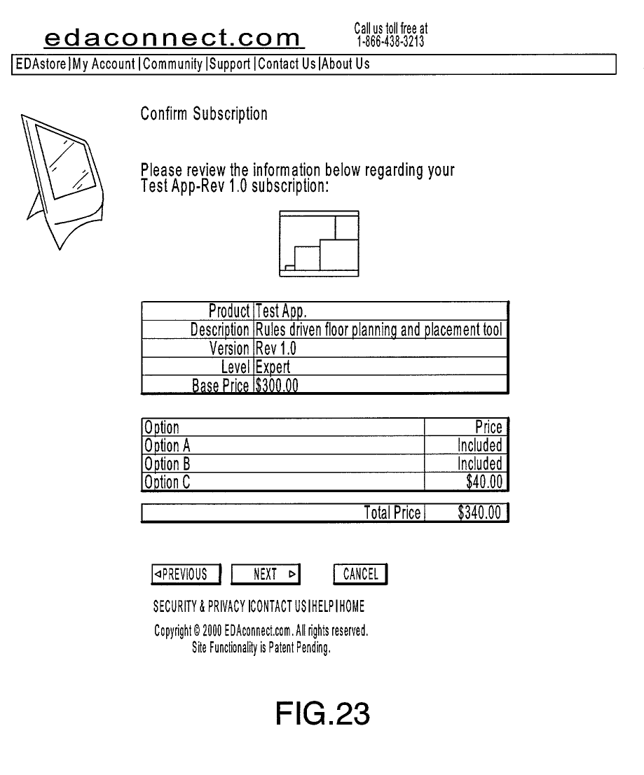

The database on the distributor computer 25 is checked to see if the user 30 has an existing account. If an account does not exist for the current user 30 (step 310), a new account is suitably created (step 314). For a new user 30, a new account is created and a subscription form is filled out (step 324). Preferably, subscription information includes for example, the user name, business name and address, e-mail, user ID, password, credit card info, application name and a number assigned to the application. After filling in the user information the user 30 may then select “submit” 902. The information may then be used by the distributor 25 to create a new account. If the vendor 40 has included various levels and options with the software application, to obtain a license, the user provides additional information by selecting the level and options desired as shown in FIG. 22. Prices for each option and level may be displayed along with features that are included in the software application. The user 30 can make selections from the displayed list based on individual needs. The user 30 is also given an opportunity to change the selected levels and options before the subscription process is completed, as shown in FIG. 23, by confirming the selections. Allowing the user 30 to customize the software application by selecting desired options provides a self-serviced environment for obtaining software via, for example, the Internet 35.

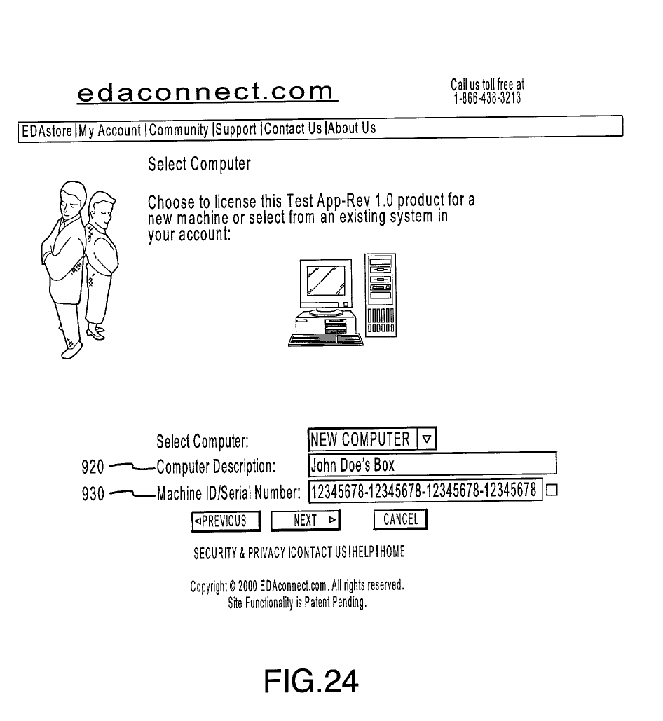

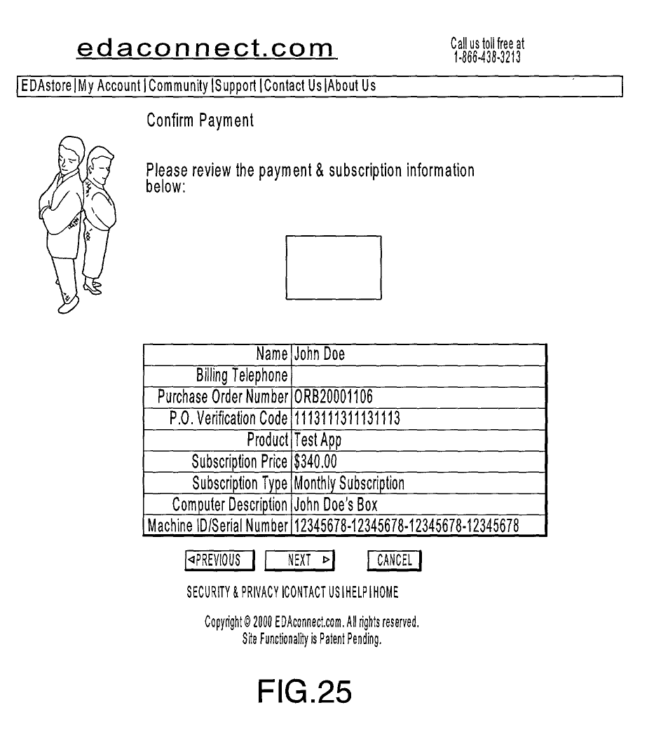

In addition to user information and the desired options, the user 30 also provides information about the computer where the software application is to be run. This allows software applications to be downloaded to a server on an intranet and then distributed to the appropriate user computer 30. FIG. 24 shows a screenshot of exemplary information entered for the user computer 30 including, for example, the machine ID 930. Alternatively, if the subscription process is initiated by the license manager the user 30 provides information regarding the computer description 920 and the license manager generates the actual machine ID 930. Information regarding the payment method is also provided by the user 30. Confirmation of the payment method, as well as other computer information, may also be provided to the user 30 before the subscription is submitted to the distributor 25 as shown in FIG. 25. In a preferred exemplary embodiment, Secure Sockets Layer (SSL) encryption, for example, may be used to secure the subscription information and maintain privacy for the user.

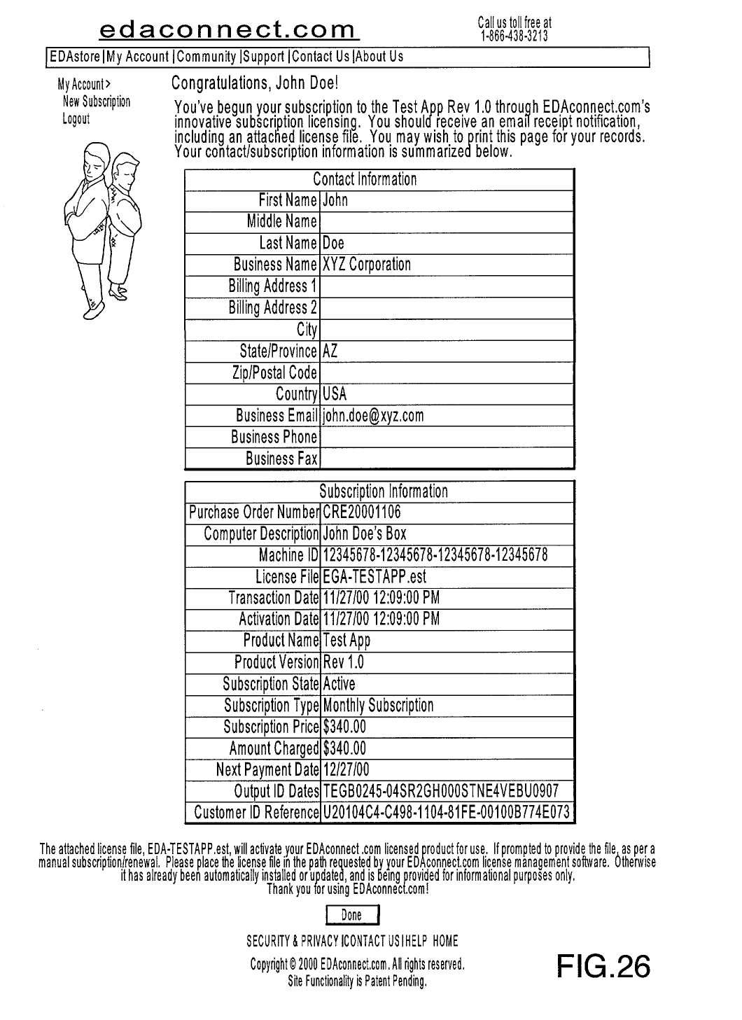

After payment information, such as credit card name and number, has been submitted to the distributor 25 (step 340) an e-commerce server determines if the credit card information is valid (step 344). If the information is valid, it is then submitted to the distributor. When the subscription and payment have been confirmed a subscription receipt is generated and displayed, for example, on the screen as shown in FIG. 26. The user information, computer information, and payment information are used to create a license file which is then stored in a database on, for example, a web server 25 (step 360). The license manager retrieves the license file from the distributor web server 25 and stores it on disk on the user computer 30 (step 368). The license file can also be e-mailed to the user 30. If the credit card information is not valid, the user 30 can edit the information (step 348) and resubmit the subscription or the subscription process can be canceled (step 364).

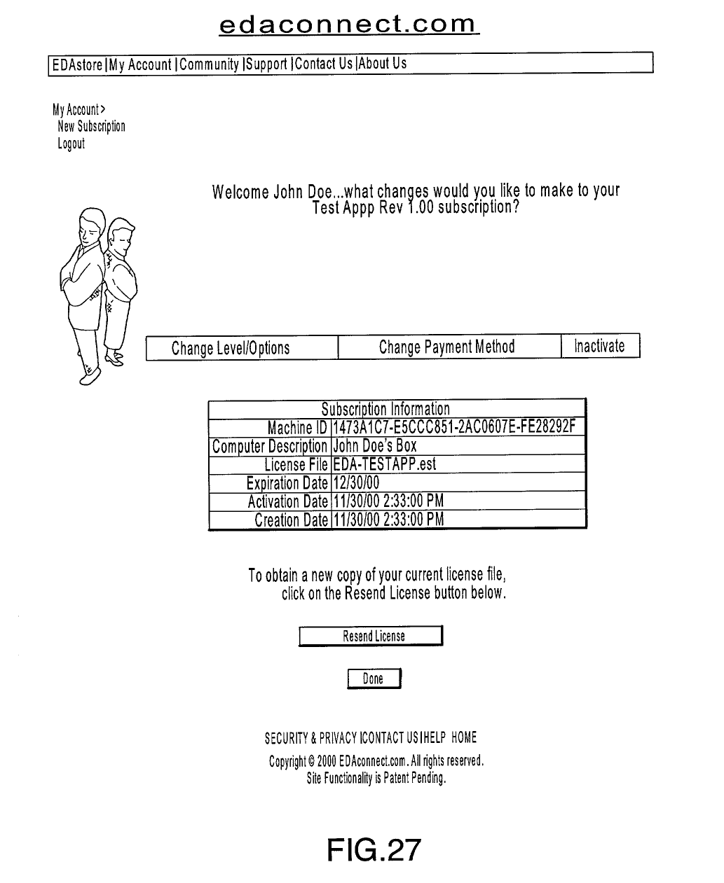

If the user 30 has an existing account, after a valid user name and password is entered, the existing account may be displayed with a summary of current subscriptions (step 320). Selecting the displayed product/software application 940/950, accesses, for example, a screen with the subscription information regarding the software application as shown in FIG. 27. These webpages allow the user 30 to, inter alia, oversee and manage the licenses obtained for software applications currently used. In this regard, the present invention offers the user 30 a turnkey solution to the acquisition and management of software tools. The present invention also allows the user 30 to step through the process in a self-serviced manner, thereby minimizing contact with, for example, high pressure sales representatives. From the account detail webpages (FIG. 27), the user 30 can obtain new subscriptions (step 328), cancel subscriptions (step 332), update subscription information (step 352) and view the applications offered in the store. If the user 30 requests a new subscription (step 328), a new form may be provided to fill in the name of and number of the new software application. When the new subscription is submitted, the e-commerce server checks the validity of the payment option (step 344). If the payment information is not valid, the user 30 may edit the information (step 348) or cancel the new subscription (step 364). If the payment information is valid, the web application (ASP) will charge the sale and create the license file on, for example, the web server (step 360). A subscription receipt may then be displayed on the screen for each new subscription.

Alternatively, if a user 30 does not have immediate or persistent access to the Internet, e-mail may be used to contact the distributor 25. The user 30 may provide the information in an e-mail and the distributor 25 can send a license file to the user 30 via return e-mail. The user 30 will then receive the software application through, for example, a CD or any other data medium now known or hereafter derived by those skilled in the art.

In another exemplary embodiment of the present invention, the distributor may use the SLS to optionally distribute other third-party vendor/developer applications. In still another exemplary embodiment, the system and method of distributing and managing software licenses according to the present invention includes a host server or other computing systems including a processor for processing digital data, a memory coupled to said processor for storing digital data, an input digitizer coupled to the processor for inputting digital data, an application program stored in said memory and accessible by said processor for directing processing of digital data by said processor, a display coupled to the processor and memory for displaying information derived from digital data processed by said processor and a plurality of databases, said databases including data that could be used in association with the present invention. The database may be any type of database, such as relational, hierarchical, object-oriented, and/or the like. Common database products that may be used to implement the database include DB2 by IBM (White Plains, N.Y.), any of the database products available from ORACLE® CORPORATION (Redwood Shores, Calif.), MICROSOFT® ACCESS by MICROSOFT® CORPORATION (Redmond, Wash.), or any other database product. The database may be organized in any suitable manner, including, for example, data tables, look-up tables or any matchable data structures now known or hereafter derived by those skilled in the art.

Association of certain data may be accomplished through any data association technique known and practiced in the art. For example, the association may be accomplished either manually or automatically. Automatic association techniques may include, for example, a database search, a database merge, GREP, AGREP, SQL, and/or the like. The association step may be accomplished by a database merge function, for example, using a “key field”. A “key field” partitions the database according to the high-level class of objects defined by the key field. For example, a certain class may be designated as a key field in both the first data table and the second data table, and the two data tables may then be merged on the basis of the class data in the key field. In this embodiment, the data corresponding to the key field in each of the merged data tables is preferably the same. However, data tables having similar, though not identical, data in the key fields may also be merged by using AGREP, for example.

The present invention may be described herein in terms of functional block components, screen shots, optional selections and various processing steps. It should be appreciated that such functional blocks may be realized by any number of hardware and/or software components configured to perform the specified functions. For example, the present invention may employ various integrated circuit components, e.g., memory elements, processing elements, logic elements, matchable data structures, and the like, which may carry out a variety of functions under the control of one or more microprocessors or other control devices. Similarly, the software elements of the present invention may be implemented with any programming or scripting language such as, for example, C, C++, Java, COBOL, assembler, PERL, eXtensible Markup Language (XML), etc., or any programming or scripting language now known or hereafter derived by those skilled in the art, with the various algorithms being implemented with any combination of data structures, objects, processes, routines or other programming elements. Further, it should be noted that the present invention may employ any number of conventional techniques for data transmission, signaling, data processing, network control, and the like. Still further, the invention could be used to detect or prevent security issues with a client-side scripting language, such as JavaScript, VBScript or the like. Again, for a basic introduction of cryptography, please read the text by Bruce Schneider entitled “Applied Cryptography: Protocols, Algorithms, And Source Code In C,” published by John Wiley & Sons (second edition, 1996), which are hereby incorporated by reference.

It should be appreciated that the particular implementations shown and described herein are illustrative of the invention and its best mode and are not intended to otherwise limit the scope of the present invention in any way. Indeed, for the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

It will be appreciated, that many applications of the present invention could be formulated. One skilled in the art will appreciate that the network may include any system for exchanging data, such as, for example, the Internet, an intranet, an extranet, WAN, LAN, satellite communications, and/or the like. It is noted that the network may be implemented as other types of networks, such as an interactive television (ITV) network. The users may interact with the system via any input device such as a keyboard, mouse, kiosk, personal digital assistant, handheld computer (e.g., Palm Pilot®), cellular phone and/or the like. Similarly, the invention could be used in conjunction with any type of personal computer, network computer, workstation, minicomputer, mainframe, or the like running any operating system such as any version of Windows, Windows XP, Windows Whistler, Windows ME, Windows NT, Windows2000, Windows 98, Windows 95, MacOS, OS/2, BeOS, Linux, UNIX, or any operating system now known or hereafter derived by those skilled in the art. Moreover, the invention may be readily implemented with TCP/IP communications protocols, IPX, Appletalk, IP-6, NetBIOS, OSI or any number of existing or future protocols. Moreover, the system contemplates the use, sale and/or distribution of any goods, services or information having similar functionality described herein.

The computing units may be connected with each other via a data communication network. The network may be a public network and assumed to be insecure and open to eavesdroppers. In one exemplary implementation, the network may be embodied as the internet. In this context, the computers may or may not be connected to the internet at all times. Specific information related to data traffic protocols, standards, and application software utilized in connection with the Internet may be obtained, for example, from DILIP NAIK, INTERNET STANDARDS AND PROTOCOLS (1998); JAVA 2 COMPLETE, various authors, (Sybex 1999); DEBORAH RAY AND ERIC RAY, MASTERING HTML 4.0 (1997). LOSHIN, TCP/IP CLEARLY EXPLAINED (1997); all of these texts having previous incorporation by reference. A variety of conventional communications media and protocols may be used for data links, such as, for example, a connection to an Internet Service Provider (ISP) over the local loop as is typically used in connection with standard modem communication, cable modem, Dish networks, ISDN, Digital Subscriber Line (DSL), or various wireless communication methods. Licensing management systems, in accordance with the present invention, might also reside within a local area network (LAN) which interfaces to a network via a leased line (T1, D3, etc.). Such communication methods are generally well known in the art, and are covered in a variety of standard texts. See, e.g., GILBERT HELD, UNDERSTANDING DATA COMMUNICATIONS (1996), hereby incorporated by reference.

As will be appreciated by one of ordinary skill in the art, the present invention may be embodied as a method, a system, a device, and/or a computer program product. Accordingly, the present invention may take the form of an entirely software embodiment, an entirely hardware embodiment, or an embodiment combining aspects of both software and hardware. Furthermore, the present invention may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

Data communication is accomplished through any suitable communication means, such as, for example, a telephone network, Intranet, Internet, point of interaction device (point of sale device, personal digital assistant, cellular phone, kiosk, etc.), online communications, off-line communications, wireless communications, and/or the like. One skilled in the art will also appreciate that, for security reasons, any databases, systems, or components of the present invention may consist of any combination of databases or components at a single location or at multiple locations, wherein each database or system includes any of various suitable security features, such as firewalls, access codes, encryption, de-encryption, compression, decompression, and/or the like.

The present invention is described herein with reference to screen shots, block diagrams and flowchart illustrations of methods, apparatus (e.g., systems), and computer program products according to various aspects of the invention. It will be understood that each functional block of the block diagrams and the flowchart illustrations, and combinations of functional blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions.

In the preceding specification, the invention has been described with reference to specific embodiments. However, it will be appreciated that various modifications and changes can be made without departing from the scope of the present invention as set forth in the claims below. The specification and figures are to be regarded in an illustrative manner, rather than a restrictive one, and all such modifications are intended to be included within the scope of present invention. Accordingly, the scope of the invention should be determined by the appended claims and their legal equivalents, rather than by merely the examples given above. For example, the steps recited in any of the method or process claims may be executed in any order and are not limited to the order presented in the claims.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as critical, required, or essential features or elements of any or all the claims. As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus. Further, no element described herein is required for the practice of the invention unless expressly described as “essential” or “critical”. Other combinations and/or modifications of the above-described structures, features, arrangements, applications, proportions, elements, materials or components used in the practice of the present invention, in addition to those not specifically recited, may be varied or otherwise particularly adapted by those skilled in the art to specific environments, manufacturing or design parameters or other operating requirements without departing from the general principles of the same.

We claim:

1. A method for managing licensing data, comprising the steps of:
providing a host system having a processor for processing digital data;
providing a client system having a processor for processing digital data and communicably connected to said host system;
providing a license management host application running on said host system, said host application having access to a licensing database;
providing a license management client application running on said client system, said client application having access to a client license datastore;
providing a user interface configured to accept licensing orders, said user interface providing a user with access for ordering a license, said user interface requesting the issuance of a license;
issuing a license from said licensing database, using said management host application, in response to a user interface request to add a license to said client license datastore;
monitoring usage of a license so issued using said management host application;
compiling and displaying at least a plurality of licenses stored in said client license datastore using said license management client application; and
communicating with said host application, using said license management client application to modify terms corresponding to at least one license stored in said client license datastore.

2. The method for managing licensing data according to claim 1, wherein said host application is administered by at least one of a vendor, a distributor, an agent, a manager, a reseller, a value-added reseller (VAR), a contractor, a sub-contractor, a subsidiary, a partner, an Original Equipment Manufacturing (OEM) provider, a licensee, a sub-licensee, a trustee, and a fiduciary.

3. The method for managing licensing data according to claim 1, wherein said communicable connection between said client system and said server system is selected from the group consisting of a LAN, a WAN, a VPN, the Internet, an extranet, an intranet, and any combination thereof.

4. The method for managing licensing data according to claim 1, wherein said licensing database is at least one of an ADO compliant database, an ODBC database, a relational database, a flat file, and an SQL compatible database.

5. The method of managing licensing data according to claim 1, further comprising the step of populating said database with default structure.

6. The method of managing licensing data according to claim 5, further comprising the step of populating said database with default data.

7. The method of managing licensing data according to claim 5, wherein said population of said database comprises licensing terms.

8. The method for managing licensing data according to claim 1, wherein said datastore is encrypted.

9. The method for managing licensing data according to claim 1, wherein said datastore is stored locally on the client system.

10. The method for managing licensing data according to claim 1, wherein said datastore is hosted from a remote location.

11. The method for managing licensing data according to claim 1, wherein a license issued by said host application is at least one of a trial license, a time-limited license, a perpetual license, a subscription-based license, and an irrevocable license.

12. The method for managing licensing data according to claim 1, wherein said client application uses a graphic user interface (GUI) for compiling at least a plurality of licenses stored in said client license datastore.

13. The method for managing licensing data according to claim 12, wherein said GUI further comprises a native file management application component of said client system's operating system.

14. The method for managing licensing data according to claim 1, wherein said modification of the terms corresponding to at least one license stored in said client license datastore further comprises a method step selected from the group consisting of deleting a license, expiring a license, terminating a license, renewing a license, manually subscribing a license, automatically subscribing a license, transferring a license, abandoning a license, reactivating a license, and any combination thereof.

15. The method for managing licensing data according to claim 1, wherein said license management host application further comprises at least one of a Terminate and Stay Resident program (TSR), an operating system service, a daemon, a stand-alone application, an applet, a protected mode application, a multi-threaded application, a parallel processed application, and a distributed processing application.

16. The method for managing licensing data according to claim 1, wherein said host application monitoring of usage of a license further comprises a method step selected from the group consisting of collecting machine identification data, collecting user identification data, tracking time of use data, tracking duration of use data, sending a cookie from said client system to said host system, and any combination thereof.

17. The method of managing licensing data according to claim 1, further comprising the licensing of a software application.

18. The method of managing licensing data according to claim 1, wherein said client system further comprises at least one of a computer, a kiosk, a web access portal, a Point of Sale (POS) terminal, a smartcard, a wireless transmitter, a portable digital assistant, a telephone, a mobile phone, a pager, and an information appliance.

19. The method of managing licensing data according to claim 1, wherein said host application further comprises tools to customize the licensing database.

20. The method of managing licensing data according to claim 1, wherein said user interface for accepting licensing orders further comprises media adapted for display on a web browser.

21. A system for managing licensing data, comprising:
a host system having a processor for processing digital data;
a client system having a processor for processing digital data and communicably connected to said host system;
a license management host application running on said host system, said host application having access to a licensing database;
a license management client application running on said client system, said client application having access to a client license datastore;
a user interface configured to accept licensing orders, said user interface providing a user with substantially self-service access for ordering a license, said user interface requesting the issuance of a license;
a management host application for issuing a license from said licensing database in response to a user interface request to add a license to said client license datastore, said management host application monitoring usage of a license so issued; and
said license management client application compiling and displaying at least a plurality of licenses stored in said client license datastore and communicating with said host application to modify terms corresponding to at least one license stored in said client license datastore.

22. The system for managing licensing data according to claim 21, wherein said host service is administered by at least one of a vendor, a distributor, an agent, a manager, a reseller, a value-added reseller (VAR), a contractor, a sub-contractor, a subsidiary, a partner, an Original Equipment Manufacturing (OEM) provider, a licensee, a sub-licensee, a trustee, and a fiduciary.

23. The system for managing licensing data according to claim 21, wherein said vendor is also a distributor.

24. A method for managing the licensing of software, comprising the steps of:
providing a host system having a processor for processing digital data;
providing a client system having a processor for processing digital data and communicably connected to said host system;
providing a license management host application running on said host system, said host application having access to a licensing database;
providing a software application to be licensed;
providing a substantially turnkey wrapping utility for securing compiled instruction code and wrapping said software application with licensing security code;
providing a license management client application running on said client system, said client application having access to a client license datastore;
providing a user interface configured to accept licensing orders, said user interface providing a user with substantially self-service access for ordering a license, said user interface requesting the issuance of a license;
issuing a license from said licensing database, using said management host application, in response to a user interface request to add a license to said client license datastore;
monitoring usage of a license so issued using said management host application;
compiling and displaying at least a plurality of licenses stored in said client license datastore using said license management client application; and
communicating with said host application, using said license management client application to modify terms corresponding to at least one license stored in said client license datastore.

25. The method for managing the licensing of software of claim 24, further comprising the step of said host service providing means for downloading said wrapped application.

26. The method for managing the licensing of software of claim 24, further comprising the steps of:
providing means for purchasing a license from said host service; and
processing payment for said purchase of a license.

27. The method for managing the licensing of software of claim 24, wherein said host application further comprises tools to customize the licensing database.

28. The method for managing the licensing of software of claim 24, wherein said host application further comprises tools to customize the wrapping of said software application.

29. The method for managing the licensing of software of claim 24, further comprising the step of encrypting said wrapped application.

30. The method for managing the licensing of software of claim 24, further comprising the step of obtaining information from a user of the license management client application to authorize access to execute said wrapped application.

31. The method for managing the licensing of software of claim 24, further comprising the step of downloading said wrapped application over a communications network.

32. The method of managing the licensing of software of claim 24, further comprising the distribution of wrapped vendor/developer software applications by a distributor.

33. The method of managing the licensing of software of claim 32, wherein the distributor is also the vendor/developer.

34. The method of managing the licensing of software of claim 24, further comprising the step of offering user-selectable software options for the wrapped application before issuing a license to execute the wrapped application.

35. The method of managing the licensing of software of claim 24, further comprising the step of providing tools to customize the functionality of said license management host application.

36. The method of managing the licensing of software of claim 24, further comprising the step of providing tools to customize the functionality of said license management client application.

37. The method of managing the licensing of software of claim 24, further comprising the step of providing tools to customize the distributor-created licensing code.

38. A method for protecting software from unlicensed use, comprising the steps of:
providing turnkey licensing code to vendors for wrapping a vendor-provided software application;
encrypting said vendor-provided software application;
wrapping distributor licensing code around said vendor-provided software application.

39. The method for protecting software from unlicensed use of claim 38, wherein said vendor is also a distributor.

40. The iterative application of the method for protecting software from unlicensed use according to claim 38, wherein the wrapped code produced in the preceding iteration is further wrapped to produce at least a second generation wrapped executable application.

41. The method for protecting software from unlicensed use according to claim 38, wherein the distributor code is compiled substantially concurrent with compilation of said vendor-provided software.

42. The method for protecting software from unlicensed use according to claim 38, wherein vendor-provided startup code is replaced with distributor-provided startup code.

43. The method for protecting software from unlicensed use of claim 42, further comprising the step of using the distributor-provided startup code as a decryption key.

44. The method for protecting software from unlicensed use according to claim 38, further comprising the step of executing said wrapped application, wherein the wrapped software application begins execution at a substantially random codebase offset entry point.

45. The method for protecting software from unlicensed use according to claim 38, further comprising the step of calculating a CRC for the wrapped application at least prior to execution of said wrapped application to determine if the wrapped application has been modified.

46. The method of protecting software from unlicensed use of claim 45, further comprising the step of disabling execution of said wrapped application if said wrapped application has been determined to have been modified.

47. The method for protecting software from unlicensed use according to claim 38, further comprising the step of monitoring execution of said wrapped application to determine if tampering attempts to said wrapped application are being made.

48. The method for protecting software from unlicensed use according to claim 47, further comprising the step of terminating execution of said wrapped application in response to said tampering attempts.

49. The method of protecting software from unlicensed use according to claim 38, further comprising the step of obtaining information from the user to validate licensing information and to permit execution of said wrapped application.

50. The method of protecting software from unlicensed use according to claim 38, further comprising the step of calculating a machine fingerprint for comparison with licensing information to authorize execution of said wrapped application.

51. The method of protecting software from unlicensed use according to claim 38, further comprising the step of providing a license on a subscription basis.

52. The method of protecting software from unlicensed use of claim 51, further comprising the step of automatically renewing said license subscription.

53. The method of protecting software from unlicensed use according to either one of claims 38, further comprising the step of providing a distributor with a system for managing licensing data according to claim 21.

54. The method of protecting software from unlicensed use according to either one of claims 38, further comprising the step of providing a vendor/developer with system for managing licensing data according to claim 21.

55. The method of protecting software from unlicensed use of claim 54, wherein the vendor/developer is also the distributor.

56. A system for providing substantially self-serviced access in a network environment to a plurality of vendor-provided software applications for electronic distribution to a remote user, said system comprising:
means for providing at least a plurality of software applications for distribution;
means for electronically distributing at least one software application;
means for protecting at least one software application so distributed from unlicensed access;
means for storing license files in a licensing database;
means for issuing a license from said licensing database to said remote user; and
means for modifying the terms of the issued license, thereby allowing said system to provide substantially self-service electronic distribution from the perspective of said remote user.

57. The system for providing substantially self-serviced access to a plurality of vendor-provided software applications according to claim 56, further comprising means for said remote user to select optional software features.

58. The system for providing substantially self-serviced access to a plurality of vendor-provided software applications according to claim 56, wherein said means for providing at least a plurality of software applications for distribution comprises a web-based storefront.

59. The system for providing substantially self-serviced access to a plurality of vendor-provided software applications according to claim 56, wherein said issued license is a subscription based license.

60. The system for providing substantially self-serviced access to a plurality of vendor-provided software applications according to claim 56, wherein said means for modifying said license comprises an automatic renewal of said license.
